(19) United States
(12) Patent Application Publication
(10) Pub. No.: US 2017/0123568 A1
(43) Pub. Date: May 4, 2017

(54) TOUCH PANEL SYSTEM AND ELECTRONIC DEVICE

(71) Applicant: Sharp Kabushiki Kaisha, Osaka (JP)

(72) Inventors: Michiaki TAKEDA, Osaka (JP); Takahiro KATAYAMA, Osaka (JP); Mamoru TAKAYA, Osaka (JP)

(73) Assignee: SHARP KABUSHIKI KAISHA, Sakai City, Osaka (JP)

(21) Appl. No.: 15/317,173

(22) PCT Filed: Jun. 22, 2015
(86) PCT No.: PCT/JP2015/067922

§ 371 Date: Dec. 8, 2016

(30) Foreign Application Priority Data
Jul. 9, 2014 (JP) 2014-141654

(51) Int. Cl. G06F 3/041; G06F 3/038; G06F 3/044; G06F 3/0354

(52) U.S. Cl. CPC G06F 3/0416; G06F 3/03545; G06F 3/0383; G06F 3/044

(57) ABSTRACT

Sensitivity of a stylus pen to a touch panel is stabilized. The stylus pen (3) includes a pen tip (31) which is provided to be movable in an axial direction in accordance with a writing pressure and a writing pressure sensor (31d) which generates a signal corresponding to the amount of movement of the pen tip (31). A threshold updating circuit (40) is provided to update a threshold for determining, by the writing pressure sensor (31d), presence or absence of the writing pressure on the basis of a distance between the stylus pen (3) and the touch panel.

### TECHNICAL FIELD

The present invention relates to a touch panel system for detecting a position on a touch panel of a touch pen in touch with the touch panel and an electronic device including the touch panel system.

### BACKGROUND ART

A configuration is known in which a writing pressure sensor sensing a writing pressure is provided in a stylus pen (touch pen) in a touch panel system for detecting a position on a touch panel of the stylus pen in touch with the touch panel.

The stylus pen has a pen tip which is provided to be movable in an axial direction in accordance with a writing pressure. The writing pressure sensor provided in the stylus pen generates a voltage signal corresponding to the amount of movement of the pin tip caused by a load. The presence or absence of a touch of the stylus pen on the touch panel is determined on the basis of the signal generated by the writing pressure sensor and a threshold established in advance.

For the above-described stylus pen, an environmental change, such as a change in a temperature around the stylus pen or a secular change in performance of a part of the stylus pen, causes a change in a voltage signal from the writing pressure sensor in the absence of a touch on the touch panel and makes it difficult to correctly determine the presence or absence of a touch.

PTL 1 discloses a configuration which obtains a long-time average of a voltage signal from a writing pressure sensor in the absence of a touch and updates a threshold of the writing pressure sensor on the basis of the long-time average.

This configuration allows the writing pressure sensor to correctly determine the presence or absence of a touch even if a voltage signal from the writing pressure sensor changes due to a change in temperature or a secular change in performance.

### CITATION LIST

### Patent Literature

PTL 1: U.S. Pat. No. 8,536,471 (Sep. 17, 2013)

### SUMMARY OF INVENTION

### Technical Problem

The above-described conventional technique, however, suffers from the problems below.

FIG. 18(a) is a schematic diagram for explaining a configuration with a stylus pen 93 and a touch panel 92, and FIG. 18(b) is a graph showing the relationship between a voltage from a writing pressure sensor 61d which is provided in the stylus pen 93 and a load applied to the writing pressure sensor 61d.

The stylus pen 93 has a pen tip 61 which is provided to be movable in an axial direction in accordance with a writing pressure and the writing pressure sensor 61d that generates a voltage signal corresponding to the amount of movement of the pen tip 61. If the pen tip 61 of the stylus pen 93 is brought into contact with the touch panel 92, and a load is applied from the pen tip 61 to the touch panel 92, the pen tip 61 moves in the axial direction of the stylus pen 93, and a voltage signal corresponding to the amount of movement of the pen tip 61 is output from the writing pressure sensor 61d. As indicated by a curve C91 in FIG. 18(b), the voltage signal decreases with an increase in the load and increases with a decrease in the load.

FIG. 19(a) is a schematic diagram for explaining transition of the action of the pen tip 61 provided in the stylus pen 93, and FIG. 19(b) is a graph showing transition of the voltage from the writing pressure sensor 61d provided in the stylus pen 93.

Whether the stylus pen 93 is in contact with the touch panel 92 (the presence or absence of a touch) needs to be determined. Basically, the presence or absence of a touch is determined through providing a threshold for a voltage value obtained from the writing pressure sensor 61d.

The stylus pen 93 that is away from the touch panel 92 comes into contact with the touch panel 92 and is subjected to a writing pressure, which results in movement of the pen tip 61 in the axial direction. If the stylus pen 93 moves away from the touch panel 92 again, the pen tip 61 is expected to return to an original position with the help of a member which causes a restoring force to act.

However, there may actually be variation in return position. More specifically, the pen tip 61 may return only to this side of the original position or may return to beyond the original position.

The degree of the variation depends on a method for designing a mechanism associated with the pen tip 61, variation in size among parts used in the mechanism, and the like. As a result, there is variation in a voltage from the writing pressure sensor 61d which is detected when the pen tip 61 is not in touch with the touch panel 92.

For example, a voltage V91 is output from the writing pressure sensor 61d of the stylus pen 93 that is away from the touch panel 92. The stylus pen 93 comes into contact with the touch panel 92 at time t91. If the writing pressure of the stylus pen 93 is increased from time t91 to time t92, the pen tip 61 moves in the axial direction toward the writing pressure sensor 61d. A voltage output from the writing pressure sensor 61d decreases from the voltage V91 to a voltage V92. If the writing pressure of the stylus pen 93 is maintained from time t92 to time t93 after that, the pen tip 61 remains at a position in the axial direction, and the voltage from the sensor 61d remains at the voltage V92.

If the writing pressure of the stylus pen 93 is decreased to zero from time t93 to time t94, the pen tip 61 moves in the axial direction in a direction away from the writing pressure sensor 61d and returns to beyond an original position before time 91. The voltage from the writing pressure sensor 61d increases to a voltage V93 higher than the original voltage V91 before time 91.

If the stylus pen 93 is moved away from the touch panel 92, and the writing pressure maintains a zero-writing-pressure state from time t94 to time t95, the pen tip 61 remains at a return position beyond the original position, and the voltage from the writing pressure sensor 61d remains at the voltage V93.

After that, the stylus pen 93 comes into contact with the touch panel 92 at time t95. If the writing pressure of the stylus pen 93 is increased again from time t95 to time t96, the pen tip 61 moves in the axial direction toward the writing pressure sensor 61d again. The voltage output from the writing pressure sensor 61d decreases from the voltage V93 to the voltage V92. After that, if the writing pressure of the stylus pen 93 is maintained from time t96 to time t97, the pen tip 61 remains at a position in the axial direction, and the voltage from the sensor 61d remains at the voltage V92.

If the writing pressure of the stylus pen 93 is decreased to zero from time t97 to time t98, the pen tip 61 moves in the axial direction in the direction away from the writing pressure sensor 61d, the pen tip 61 returns to a position on this side of the original position before time 91. The voltage from the writing pressure sensor 61d increases to a voltage V94 lower than the original voltage V91 before time 91.

As described above, a voltage from the writing pressure sensor 61d which is detected when the pen tip 61 is not in touch with the touch panel 92 is the voltage V91 before time t91, is the voltage V93 from time t94 to time t95, and is the voltage V94 at and after time t98. Thus, there is a problem in that each time the stylus pen 93 is pushed into and moved away from the touch panel 92, the voltage from the writing pressure sensor 61d in a non-touch state varies.

In view of operability for a user who operates the stylus pen 93, it is preferable that determination of the presence or absence of a touch is performed as sensitively and accurately as possible in response to a slight contact of the pen tip 61 with the touch panel 92.

Assume that a voltage not less than the voltage V94 shown in FIG. 19(b) is determined as the absence of a touch to prevent erroneous determination in the presence of the above-described variation. In this case, the presence of a touch is not determined unless the pen tip 61 is pushed into the touch panel 92 slightly hard to time t99 after the stylus pen 93 is brought into contact with the touch panel 92 at time t95, and the voltage from the writing pressure sensor 61d decreases from the voltage V91 to below the voltage V94. For this reason, there is a problem in that the sensitivity of the stylus pen 93 may be felt unstable.

An object of the present invention is to provide a touch panel system and an electronic device, in which sensitivity of a stylus pen to a touch panel is stable even if a return position of a pen tip varies each time the stylus pen is pushed into and moved away from the touch panel.

### Solution to Problem

To solve the above-described problems, a touch panel system according to one aspect of the present invention is a touch panel system for detecting a position on a touch panel of a touch pen in touch with the touch panel, in which the touch pen includes a pen tip which is provided to be movable in an axial direction in accordance with a writing pressure and a writing pressure sensor which generates a signal corresponding to the amount of movement of the pen tip, and a threshold updating circuit is provided to update a threshold for determining, by the writing pressure sensor, presence or absence of the writing pressure on the basis of a distance between the touch pen and the touch panel.

To solve the above-described problems, an electronic device according to one aspect of the present invention includes a touch panel system according to the one aspect of the present invention.

### Advantageous Effects of Invention

According to one aspect of the present invention, even if a return position of a pen tip varies each time a stylus pen is pushed into and moved away from a touch panel, sensitivity of the stylus pen to the touch panel is advantageously stable.

### BRIEF DESCRIPTION OF DRAWINGS

FIG. 1 is a block diagram showing the configuration of a touch panel system according to a first embodiment.

FIG. 2 is a wiring diagram showing the configuration of a touch panel provided in the touch panel system.

FIG. 3 is a circuit diagram showing the configuration of a multiplexer for switching connection between signal lines connected to the touch panel and drive lines connected to a driver and sense lines connected to a sense amplifier.

FIG. 4 is a block diagram showing the configuration of a stylus pen in the touch panel system.

FIG. 5 is a timing diagram showing basic action for synchronization in the stylus pen.

FIG. 6(a) is a diagram showing a relationship of output from the drive lines of the driver and the sense lines of the sense amplifier in a touch panel controller to the touch panel and the stylus pen, and FIG. 6(b) is a waveform chart showing a synchronizing waveform and a touch detection waveform.

FIG. 7(a) is a schematic diagram showing an aspect in which the touch panel controller drives the touch panel by using synchronizing signals, and FIG. 7(b) is a schematic diagram showing an aspect in which the touch panel controller drives the touch panel by using driving signals for detecting a position of the stylus pen.

FIG. 8(a) is a schematic diagram showing a position of the stylus pen relative to the touch panel when the touch panel controller is driving the touch panel by using synchronizing signals, FIG. 8(b) is a schematic diagram showing another position of the stylus pen relative to the touch panel, and FIG. 8(c) is a schematic diagram showing still another position of the stylus pen relative to the touch panel.

FIG. 9 is a graph showing the relationship between the amplitude of a synchronizing signal detected by the stylus pen and the distance of the stylus pen from the touch panel.

FIG. 10(a) is a schematic diagram for explaining transition of the positional relationship of the stylus pen with the touch panel, FIG. 10(b) is a graph showing transition of a voltage from a writing pressure sensor provided in the stylus pen, and FIG. 10(c) is a graph showing transition of the amplitude of a synchronizing signal detected by the stylus pen.

FIG. 11(a) is a graph showing transition of a voltage from a writing pressure sensor provided in a stylus pen according to a second embodiment and thresholds for determining the presence or absence of a writing pressure by the writing pressure sensor, and FIG. 11(b) is a graph showing transition of the amplitude of a synchronizing signal detected by the stylus pen.

FIG. 12 is a schematic diagram showing the configuration of a touch panel system according to a third embodiment.

FIG. 13(a) is a schematic diagram for explaining a positional relationship between a touch panel and a stylus pen in the touch panel system according to the third embodiment, and FIG. 13(b) is a waveform chart showing a pen signal amplitude obtained by a touch panel controller in response to a pen driving signal output by the stylus pen of the touch panel system.

FIG. 14(a) is a schematic diagram for explaining another positional relationship between the touch panel and the stylus pen in the touch panel system, and FIG. 14(b) is a waveform chart showing a pen signal amplitude obtained by the touch panel controller for a pen driving signal associated with the positional relationship.

FIG. 15(a) is a schematic diagram for explaining still another positional relationship between the touch panel and the stylus pen in the touch panel system, and FIG. 15(b) is a waveform chart showing a signal amplitude obtained by the touch panel controller in response to a pen driving signal associated with the positional relationship.

FIG. 16 is a graph showing the relationship between a pen signal amplitude obtained by the touch panel controller in response to a pen driving signal output by the stylus pen and the distance of the stylus pen from the touch panel.

FIG. 17 is a block diagram showing the configuration of a mobile phone handset according to a fourth embodiment.

FIG. 18(a) is a schematic diagram for explaining a configuration with a stylus pen and a touch panel, and FIG. 18(b) is a graph showing the relationship between a voltage from a writing pressure sensor provided in the stylus pen and a load applied to the writing pressure sensor.

FIG. 19(a) is a schematic diagram for explaining transition of the action of a pen tip provided in the stylus pen, and FIG. 19(b) is a graph showing transition of a voltage from the writing pressure sensor provided in the stylus pen.

### DESCRIPTION OF EMBODIMENTS

### First Embodiment

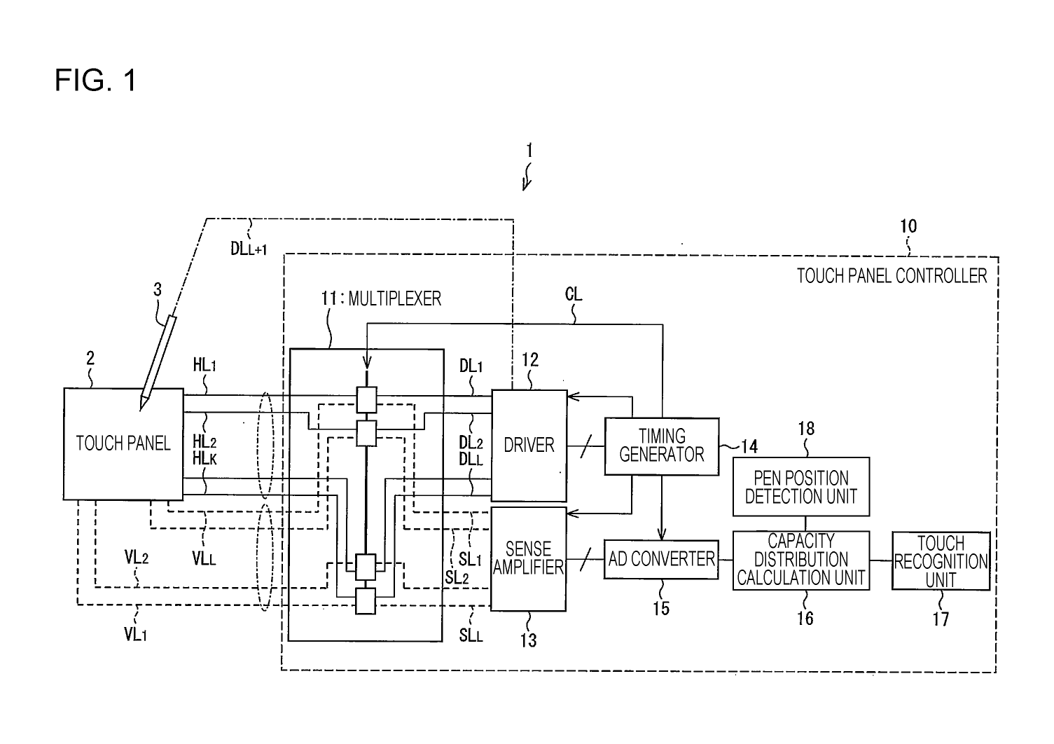

Embodiments of the present invention will be described below with reference to FIGS. 1 to 10 as follows.

### (Configuration of Touch Panel System 1)

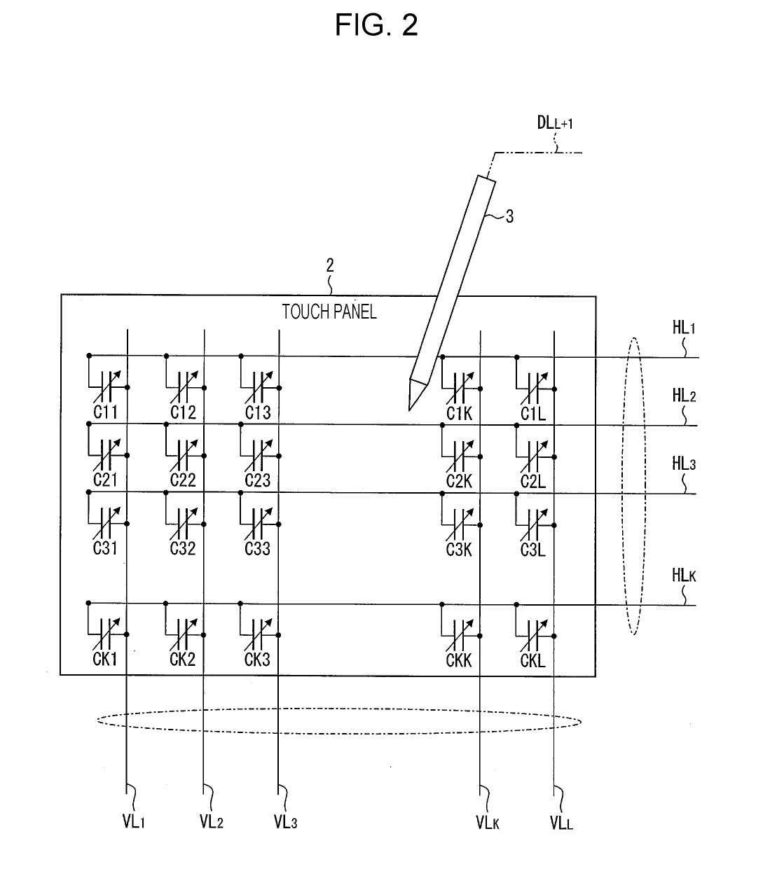

The configuration of a touch panel system 1 according to the present embodiment will be described with reference to FIGS. 1 and 2. FIG. 1 is a block diagram showing the configuration of the touch panel system 1 according to the present embodiment, and FIG. 2 is a wiring diagram showing the configuration of a touch panel 2 which is provided in the touch panel system 1.

As shown in FIG. 1, the touch panel system 1 according to the present embodiment includes the touch panel 2, a stylus pen (touch pen) 3, and a touch panel controller (control unit) 10 which drives the touch panel 2 and the stylus pen 3.

As shown in FIG. 2, the touch panel 2 includes K (K is a positive integer) horizontal signal lines HL₁ to HL_{K} which are arranged parallel to each other along a horizontal direction and L (L is a positive integer) vertical signal lines VL₁ to VL_{L} which are arranged parallel to each other along a vertical direction. Capacitors C11 to CKL are formed at respective intersections of the horizontal signal lines HL₁ to HL_{K} and the vertical signal lines VL₁ to VL_{L}. Note that although K and L may be equal to or different from each other, the present embodiment will be described, assuming that L≧K. In the present embodiment, the horizontal signal lines HL₁ to HL_{K} and the vertical signal lines VL₁ to VL_{L} intersect with each other at right angles. The present invention, however, is not limited to this, and intersection of the horizontal signal lines HL₁ to HL_{K} and the vertical signal lines VL₁ to VL_{L} with each other suffices.

The touch panel 2 is preferably wide enough to place a hand grasping the stylus pen 3 on but may have a suitable size to use in a smartphone.

In the present embodiment, the stylus pen 3 is not just a touch pen which is made of a conductor for contact with the touch panel 2 and is composed of a pen which allows signal input and output. As will be described later, a synchronizing signal detecting circuit (synchronizing circuit) 36 is provided in the stylus pen 3, and a synchronizing signal for synchronization with a dedicated synchronizing signal generated in a timing generator 14 of the touch panel controller 10 is received by and input to the stylus pen 3.

As shown in FIG. 1, the touch panel controller 10 includes a multiplexer 11, a driver 12, a sense amplifier 13, the timing generator 14, an AD converter 15, a capacity distribution calculation unit 16, a touch recognition unit 17, and a pen position detection unit 18.

The driver 12 applies a voltage to drive lines DL₁ to DL_{K} or drive lines DL₁ to DL_{L} in accordance with which one of the horizontal signal lines HL₁ to HL_{K} and the vertical signal lines VL₁ to VL_{L} in the touch panel 2 to drive.

At the time of driving the horizontal signal lines HL₁ to HL_{K} in a first signal line driving period, the sense amplifier 13 reads out linear sum signals corresponding to signals of charges corresponding to the respective capacitors C11 to CKL of the touch panel 2 and first pen driving signals (pen driving signals) which are touch-time charges corresponding to respective electrostatic capacities between the stylus pen 3 and the L vertical signal lines VL₁ to VL_{L} at the time of a touch, through sense lines SL₁ to SL_{K}, and supplies the linear sum signals to the AD converter 15. That is, during detection of charges corresponding to the respective capacitors C11 to CKL in the first signal line driving period, if the stylus pen 3 is brought closer to a given position of the touch panel 2, an electrostatic capacity of a capacitor at the position changes. The amount of charge corresponding to the changed electrostatic capacity can be detected as a linear sum signal. Generally, if the stylus pen 3 is brought closer to the touch panel 2, the electrostatic capacity of a corresponding one of the capacitors C11 to CKL at a position, to which the stylus pen 3 is closer, increases.

At the time of driving the vertical signal lines VL₁ to VL_{L} in a second signal line driving period, the sense amplifier 13 reads out linear sum signals corresponding to signals of charges corresponding to the respective capacitors C11 to CKL of the touch panel 2 and second pen driving signals (pen driving signals) representing charges corresponding to respective capacitor electrostatic capacities between the stylus pen 3 and the K horizontal signal lines HL₁ to HL_{K} at the time of a touch, through sense lines SL₁ to SL_{L}, and supplies the linear sum signals to the AD converter 15.

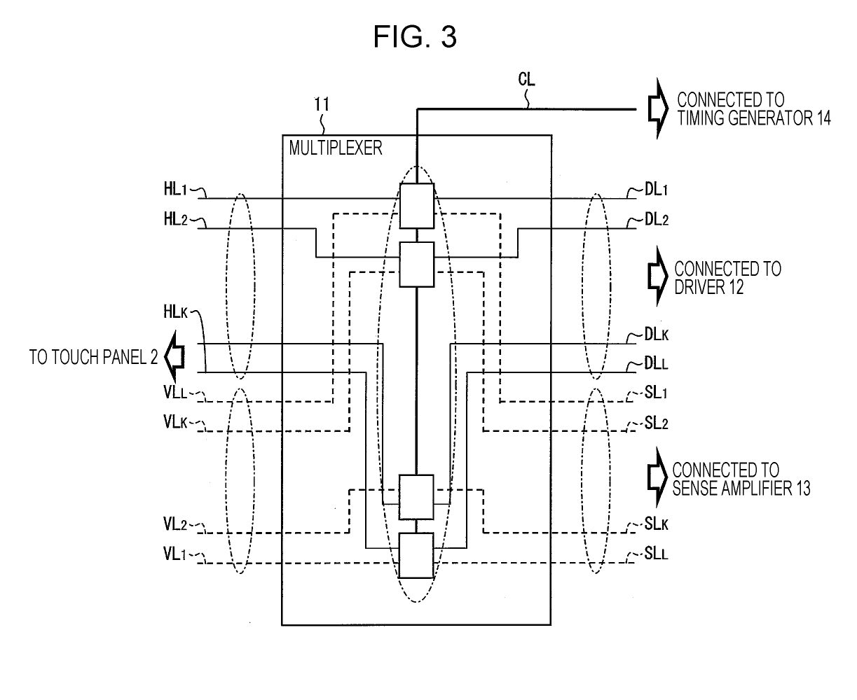

The multiplexer 11 will next be described with reference to FIG. 3. FIG. 3 is a circuit diagram showing the configuration of the multiplexer that switches connection between the horizontal signal lines HL₁ to HL_{K} or the vertical signal lines VL₁ to VL_{K} to VL_{L} provided in the touch panel 2 and the drive lines DL₁ to DL_{K} to DL_{L} connected to the driver or the sense lines SL₁ to SL_{K} to SL_{L} connected to the sense amplifier 13.

The multiplexer 11 is a connection selector circuit which switches connection between a plurality of inputs and a plurality of outputs back and forth. As shown in FIG. 3, in the present embodiment, the multiplexer 11 switches between a first connection state where the horizontal signal lines HL₁ to HL_{K} are connected to the drive lines DL₁ to DL_{K} of the driver 12, and the vertical signal lines VL₁ to VL_{K} to VL_{L} are connected to the sense lines SL₁ to SL_{K} to SL_{L} of the sense amplifier 13 and a second connection state where the horizontal signal lines HL₁ to HL_{K} are connected to the sense lines SL₁ to SL_{K} of the sense amplifier 13, and the vertical signal lines VL₁ to VL_{K} to VL_{L} are connected to the drive lines DL₁ to DL_{K} to DL_{L} of the driver 12.

In the multiplexer 11, if a signal of a control line CL shown in FIG. 3 is set to low, the horizontal signal lines HL₁ to HL_{K} are connected to the drive lines DL₁ to DL_{K}, and the vertical signal lines VL₁ to VL_{L} are connected to the sense lines SL₁ to SL_{L}. On the other hand, if the signal of the control line CL is set to high, the horizontal signal lines HL₁ to HL_{K} are connected to the sense lines SL₁ to SL_{K}, and the vertical signal lines VL₁ to VL_{L} are connected to the drive lines DL₁ to DL_{L}.

The timing generator 14 shown in FIG. 1 then generates a signal defining the action of the driver 12, a signal defining the action of the sense amplifier 13, and a signal defining the action of the AD converter 15 and supplies the signals to the driver 12, the sense amplifier 13, and the AD converter 15, respectively. The timing generator 14 also generates a synchronizing signal. The touch panel controller 10 uses a synchronizing signal generated by the timing generator 14 as a dedicated synchronizing signal to drive the horizontal signal lines HL₁ to HL_{K} and the vertical signal lines VL₁ to VL_{L}.

In a first signal line driving period, the AD converter 15 then AD-converts linear sum signals corresponding to charges corresponding to the respective capacitors C11 to CKL and first pen driving signals (pen driving signals) which are charges corresponding to electrostatic capacities between the stylus pen 3 and the L vertical signal lines VL₁ to VL_{L}, the charges and the first pen driving signals being read out through the vertical signal lines VL₁ to VL_{L} and the sense lines SL₁ to SL_{L}, and supplies the AD-converted linear sum signals to the capacity distribution calculation unit 16.

In a second signal line driving period, the AD converter 15 AD-converts linear sum signals corresponding to charges corresponding to the respective capacitors C11 to CKL and second pen driving signals (pen driving signals) which are charges corresponding to electrostatic capacities between the stylus pen 3 and the K horizontal signal lines HL₁ to HL_{K}, the charges and the second pen driving signals being read out through the horizontal signal lines HL₁ to HL_{K} and the sense lines SL₁ to SL_{K}, and supplies the AD-converted linear sum signals to the capacity distribution calculation unit 16.

The capacity distribution calculation unit 16 then calculates an electrostatic capacity distribution on the touch panel 2, a distribution of respective electrostatic capacities between the stylus pen 3 and the L vertical signal lines VL₁ to VL_{L}, and a distribution of respective electrostatic capacities between the stylus pen 3 and the K horizontal signal lines HL₁ to HL_{K} on the basis of the linear sum signals including the first pen driving signals and the second pen driving signals and a code sequence based on the driving, and supplies the electrostatic capacity distribution on the touch panel 2 to the touch recognition unit 17 and the distribution of respective electrostatic capacities between the stylus pen 3 and the L vertical signal lines VL₁ to VL_{L} and the distribution of respective electrostatic capacities between the stylus pen 3 and the K horizontal signal lines HL₁ to HL_{K} to the pen position detection unit 18 as position detection means. The touch recognition unit 17 recognizes a touched position on the touch panel 2 on the basis of the electrostatic capacity distribution supplied from the capacity distribution calculation unit 16.

The pen position detection unit 18 detects a position along the horizontal signal line HL₁ of the stylus pen 3 on the basis of the distribution of respective electrostatic capacities between the stylus pen 3 and the L vertical signal lines VL₁ to VL_{L}. The pen position detection unit 18 also detects a position along the vertical signal line VL₁ of the stylus pen 3 on the basis of the distribution of respective electrostatic capacities between the stylus pen 3 and the K horizontal signal lines HL₁ to HL_{K}.

### (Action of Detecting Touch Position of Stylus Pen 3)

The action of detecting a touch position of the stylus pen 3 in the touch panel system 1 with the above-described configuration will be chronologically described below. Note that a detection action when the stylus pen 3 is just used as a touch pen will be described here.

In a first signal line driving period, in the first connection state, in which the horizontal signal lines HL₁ to HL_{K} are connected to the drive lines DL₁ to DL_{K} of the driver 12, and the vertical signal lines VL₁ to VL_{L} are connected to the sense lines SL₁ to SL_{L} of the sense amplifier 13, the driver 12 applies a voltage to the drive lines DL₁ to DL_{K} and drives the horizontal signal lines HL₁ to HL_{K}.

In the first signal line driving period, L first linear sum signals, based on charges accumulated in the respective capacitors C11 to CKL due to the driving of the horizontal signal lines HL₁ to HL_{K} and first pen driving signals (pen driving signals) which are charges corresponding to respective electrostatic capacities between the stylus pen 3 and the L vertical signal lines VL₁ to VL_{L} when the stylus pen 3 is brought closer to the touch panel 2, are output from the L respective vertical signal lines VL₁ to VL_{L}.

The sense amplifier 13 reads out the L first linear sum signals including the first pen driving signals via the multiplexer 11 and the sense lines SL₁ to SL_{L} and supplies the L first linear sum signals to the AD converter 15. The AD converter 15 AD-converts the L first linear sum signals including the first pen driving signals and outputs the L AD-converted first linear sum signals to the capacity distribution calculation unit 16.

To interchange drive signals and sense signals between the horizontal signal lines HL₁ to HL_{K} and the vertical signal lines VL₁ to VL_{L}, the multiplexer 11 then switches from the first connection state to the second connection state. That is, in the second connection state, the horizontal signal lines HL₁ to HL_{K} are connected to the sense lines SL₁ to SL_{K} of the sense amplifier 13 while the vertical signal lines VL₁ to VL_{L} are connected to the drive lines DL₁ to DL_{L} of the driver 12.

After that, the driver 12 applies a voltage to the drive lines DL₁ to DL_{L} and drives the vertical signal lines VL₁ to VL_{L}.

In a second signal driving period, K second linear sum signals, based on charges accumulated in the respective capacitors C11 to CKL due to the driving of the vertical signal lines VL₁ to VL_{L} and second pen driving signals (pen driving signals) which are charges corresponding to respective electrostatic capacities between the stylus pen 3 and the K horizontal signal lines HL₁ to HL_{K}, are output from the K respective horizontal signal lines HL₁ to HL_{K}. In this case, the sense amplifier 13 reads out the K second linear sum signals including the second pen driving signals via the multiplexer 11 and the sense lines SL₁ to SL_{K} and supplies the K second linear sum signals to the AD converter 15. The AD converter 15 AD-converts the K second linear sum signals including the second pen driving signals and outputs the K AD-converted second linear sum signals to the capacity distribution calculation unit 16.

In a position detection step, the capacity distribution calculation unit 16 then calculates an electrostatic capacity distribution on the touch panel 2 on the basis of the first linear sum signals including the first pen driving signals and the second linear sum signals including the second pen driving signals, and supplies the electrostatic capacity distribution to the touch recognition unit 17. The capacity distribution calculation unit 16 also calculates a position along the horizontal signal line HL₁ of the stylus pen 3 and a position along the vertical signal line VL₁ of the stylus pen 3 and supplies the positions to the pen position detection unit 18.

After that, the touch recognition unit 17 recognizes a touched position on the touch panel 2 on the basis of the electrostatic capacity distribution supplied from the capacity distribution calculation unit 16.

The pen position detection unit 18 detects a position on the touch panel 2 of the stylus pen 3 on the basis of the position along the horizontal signal line HL₁ of the stylus pen 3 and the position along the vertical signal line VL₁ of the stylus pen 3 that are calculated by the capacity distribution calculation unit 16.

Note that, in the above description, both the horizontal signal lines HL₁ to HL_{K} and the vertical signal lines VL₁ to VL_{L} are driven in parallel and concurrently in the present embodiment. That is, parallel driving is performed. Note that the present invention, however, is not limited to this and that either one of parallel driving and sequential driving may be used to drive the K horizontal signal lines HL₁ to HL_{K} and the L vertical signal lines VL₁ to VL_{L} in the touch panel 2. Parallel driving refers to driving the K horizontal signal lines HL₁ to HL_{K} or the L vertical signal lines VL₁ to VL_{L} in parallel and concurrently. Sequential driving refers to sequentially driving the K horizontal signal lines HL₁ to HL_{K} or the L vertical signal lines VL₁ to VL_{L} in order from the horizontal signal line HL₁ or the vertical signal line VL₁. Parallel driving is preferable in terms of speed, and parallel driving is adopted in the present embodiment.

As described above, the touch panel system 1 according to the present embodiment includes the touch panel 2 having respective capacitors formed at intersections of a plurality of first signal lines and a plurality of second signal lines, the stylus pen 3, and the touch panel controller 10. The touch panel controller 10 lets the stylus pen 3 touch the touch panel 2 when the touch panel controller 10 is iteratively performing switch driving that drives the horizontal signal lines HL₁ to HL_{K} that are the plurality of first signal lines and causes charge signals based on electrostatic capacities of the respective capacitors to be output from the vertical signal lines VL₁ to VL_{L} that are the second signal lines in a first signal line driving period, and drives the vertical signal lines VL₁ to VL_{L} that are the plurality of second signal lines and causes charge signals based on the electrostatic capacities of the respective capacitors to be output from the horizontal signal lines HL₁ to HL_{K} that are the first signal lines in a second signal line driving period. The touch panel controller 10 detects a touch position on the basis of a change in electrostatic capacity caused by the stylus pen 3.

In a method for detecting a coordinate position of the stylus pen 3 in the touch panel system 1 with the above-described configuration, if the stylus pen 3 touches the touch panel 2, a detected position in a first signal line driving period and a detected position in a second signal line driving period are at the same position. In contrast, an error signal based on phantom noise, arising from a touch of a hand, a finger, or the like of a human body influenced by electromagnetic noise on the touch panel 2, may appear in a first signal line driving period but may not appear at the same position in a second signal line driving period, due to switching between the first signal lines and the second signal lines. It is thus possible to distinguish a signal of touch of the stylus pen 3 from an error signal based on phantom noise and remove an error signal based on phantom noise by determining a detected position using a logical product of a detected position in a first signal line driving period and a detected position in a second signal line driving period.

Note that phantom noise refers to noise as a detected signal based on static electricity generated at a position different from a touch position of the stylus pen 3 via a hand gripping the stylus pen 3. Since the position is not a proper touch position of the stylus pen 3, the detected signal is regarded as noise.

### (Configuration of Stylus Pen 3 and Function of Writing Pressure Sensor 31d)

The stylus pen 3 according to the present embodiment includes, for example, a writing pressure sensor 31d for sensing a writing pressure, and a writing pressure signal is output from the writing pressure sensor 31d in synchronization with the touch panel controller 10.

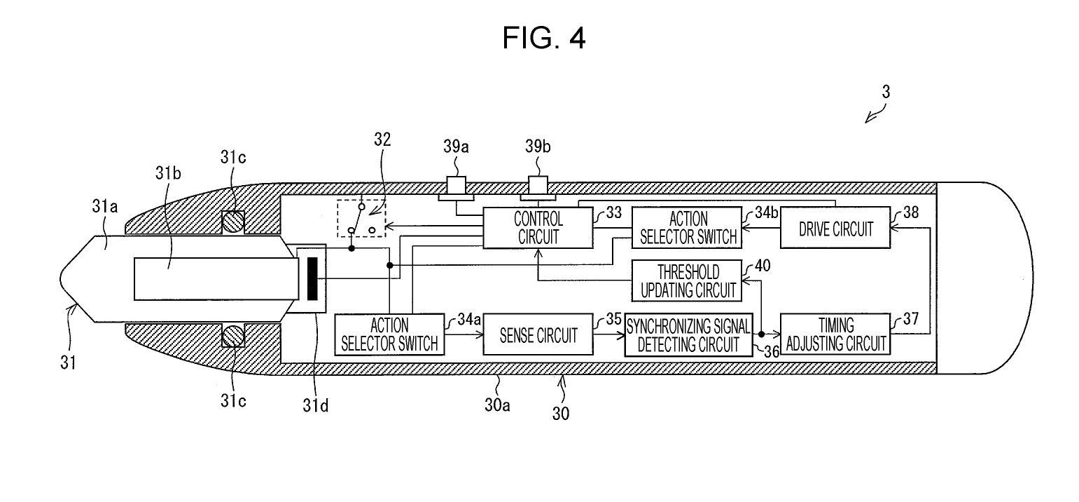

The configuration of the stylus pen 3 will be described with reference to FIG. 4. FIG. 4 is a cross-sectional view showing the configuration of the stylus pen 3.

As shown in FIG. 4, the stylus pen 3 includes a pen main body 30 to be gripped with a hand by a user which includes a conductive grasp unit 30a formed in a substantially cylindrical shape to be gripped with a hand by a user. A pen tip 31 which is pushed against the touch panel 2 at the time of a touch operation is provided at a distal end of the pen main body 30.

The pen tip 31 includes a pen tip cover 31a, a pen tip shaft 31b, and insulators 31c and 31c which hold the pen tip cover 31a such that the pen tip cover 31a is capable of moving forward in an axial direction. The writing pressure sensor 31d is provided behind the pen tip shaft 31b.

The pen tip cover 31a is made of an insulating material, and the pen tip shaft 31b is made of a conductive material, such as metal or a conductive synthetic resin material.

The writing pressure sensor 31d is composed of, for example, a semiconductor piezoresistive pressure sensor, and a semiconductor strain gauge is formed on a surface of a diaphragm (not shown). Thus, if the pen tip cover 31a of the pen tip 31 is pushed against the touch panel 2 at the time of a touch operation, the pen tip shaft 31b is pushed in via the pen tip cover 31a, and the surface of the diaphragm of the writing pressure sensor 31d is pressed. A change in electrical resistance due to a piezoresistance effect which arises from deformation of the diaphragm is converted into an electrical signal. This configuration allows detection of a writing pressure in the stylus pen 3. As described above, the pen tip 31 is provided to be movable in the axial direction of the stylus pen 3 in accordance with the writing pressure, and the writing pressure sensor 31d generates a signal corresponding to the amount of movement of the pen tip 31.

Note that a principle of writing pressure detection is not limited to this and that any other detection principle may be adopted. For example, a writing pressure may be detected with a configuration in which a pen tip moves in an axial direction in accordance with a writing pressure to disconnect an LED and a photodiode from each other.

A connection switch 32, a control circuit 33, action selector switches 34a and 34b, a sense circuit (synchronizing circuit) 35, a synchronizing signal detecting circuit (synchronizing circuit) 36, a timing adjusting circuit 37, a drive circuit (pen driving circuit) 38, and a threshold updating circuit 40 are provided inside the pen main body 30. Note that the connection switch 32 may be omitted. If the connection switch 32 is omitted, an output of the control circuit 33 is connected to, for example, a reference potential (GND).

The connection switch 32 is an electronic switch which is composed of a field effect transistor (FET) or the like and is subjected to on-off control by the control circuit 33. If the connection switch 32 is off, the pen tip shaft 31b is electrically cut off from the grasp unit 30a of the pen main body 30. Since an electrostatic capacity between the pen tip 31 and the touch panel 2 is small in this case, even if the pen tip cover 31a is brought closer to the touch panel 2, the stylus pen 3 may have difficulty acquiring a synchronizing signal from the touch panel 2.

On the other hand, if the connection switch 32 is on, the pen tip shaft 31b is electrically connected to the grasp unit 30a of the pen main body 30, and a human body is electrically continuous with the pen tip shaft 31b via the grasp unit 30a. Since the human body has a relatively large electrostatic capacity, if the stylus pen 3 approaches and come into contact with the touch panel 2, the stylus pen 3 may easily acquire a synchronizing signal from the touch panel 2.

The stylus pen 3 is provided with, for example, a first operation switch 39a and a second operation switch 39b which are of a push button type. By pressing and operating the first operation switch 39a and the second operation switch 39b, functions assigned to the first operation switch 39a and the second operation switch 39b are executed via the control circuit 33. Examples of the function assigned to the first operation switch 39a include an eraser function. Activation and deactivation of the eraser function can be performed with the first operation switch 39a. Examples of the function assigned to the second operation switch 39b include a mouse right-click function. Activation and deactivation of the mouse right-click function can be performed with the second operation switch 39b.

Note that the eraser function and the mouse right-click function are illustrative only and that the functions are not limited to the eraser function and the mouse right-click function. It is also possible to provide another operation switch and add another function.

Signals of touch of the stylus pen 3 on the touch panel 2, that is, first pen driving signals and second pen driving signals as described earlier are obtained by causing the stylus pen 3 to touch the touch panel 2 while the connection switch 32 of the stylus pen 3 is on. As described earlier, a touch position is detected by driving with switching between the horizontal signal lines HL₁ to HL_{K} and the vertical signal lines VL₁ to VL_{L}.

To detect driving of the pen tip 31 in the stylus pen 3 with the help of the touch panel controller 10, the present embodiment adopts the method below in driving of the stylus pen 3 by the drive circuit 38. In the method, a pattern of the driving is made to coincide with a pattern of driving of a horizontal signal line HL_{K+1} (or a subsequent one) of the touch panel 2 by the touch panel controller 10, that is, a pattern of driving of a (K+1)-th (or subsequent) drive line DL_{K+1} (or a subsequent one) of the driver 12 in a first signal line driving period, and is made to coincide with a pattern of driving of a vertical signal line VL_{L+1} (or a subsequent one) of the touch panel 2 by the touch panel controller 10, that is, a pattern of driving of an (L+1)-th (or subsequent) drive line DL_{L+1} (or a subsequent one) of the driver 12 in a second signal line driving period. Here, the horizontal signal line HL_{K+1} (or the subsequent one) and the vertical signal line VL_{L+1} (or the subsequent one) themselves are not present.

Note that although the pattern of the driving may be different (for example, the drive line DL_{K+1} or the drive line DL_{L+1}) for different driving periods (K≠L), the term drive line DL_{L+1} is used, and the drive line DL_{L+1} is indicated by a phantom line, for visibility in FIGS. 1 and 2. In the description below, the term drive line DL_{L+1} will be used.

### (Basic Action of Synchronization of Touch Panel Controller 10 and Stylus Pen 3)

The stylus pen 3 according to the present embodiment wirelessly performs signal transmission and reception with the touch panel controller 10. Thus, the pen tip 31 is driven in the same pattern as a pattern, in which driving of the drive line DL_{L+1} is timed to driving of the drive lines DL₁ to DL_{L} in the touch panel controller 10. In the stylus pen 3, the drive circuit 38 is provided to perform driving in the same manner as the driver 12 of the touch panel controller 10.

Driving of the drive lines DL₁ to DL_{L} in the touch panel controller 10 is based on a driving timing pulse generated in the timing generator 14. For this reason, the stylus pen 3 needs to operate in synchronization with timing of driving by the touch panel controller 10. In the stylus pen 3 according to the present embodiment, the sense circuit 35, the synchronizing signal detecting circuit 36, and the timing adjusting circuit 37 are provided. With the provision, the stylus pen 3 detects a dedicated synchronizing signal driven by the touch panel controller 10 and causes timing of the dedicated synchronizing signal of the touch panel controller 10 and timing of a pen synchronizing signal generated by the timing adjusting circuit 37 in the stylus pen 3 to coincide with each other.

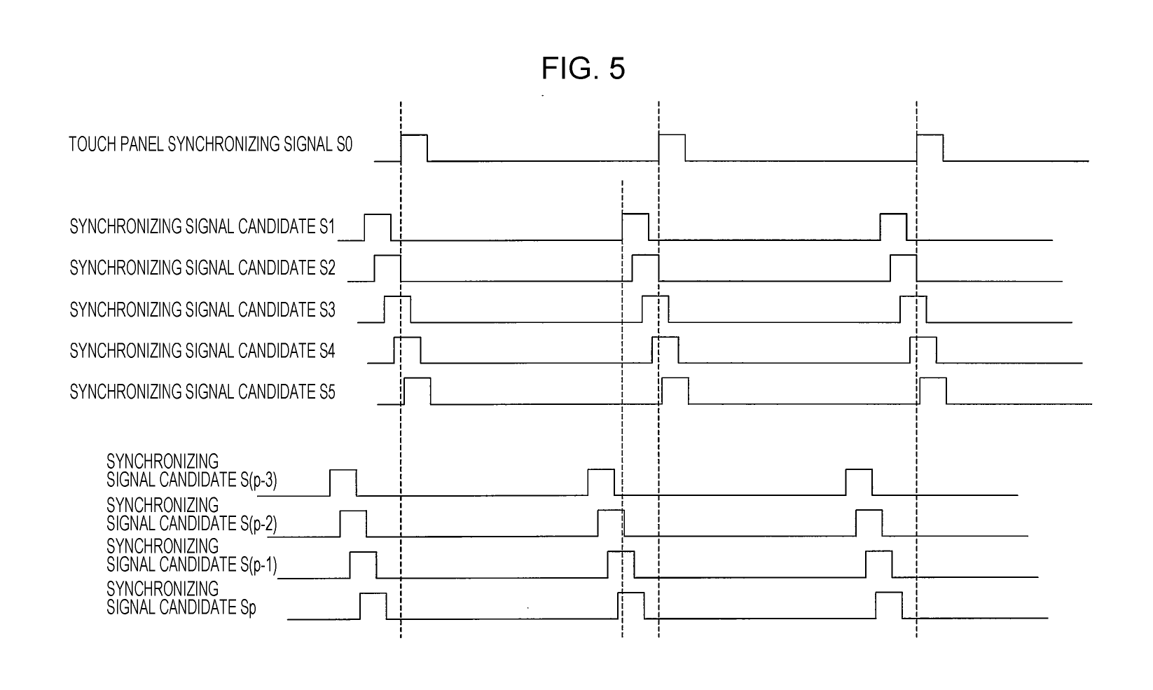

The basic principle of synchronization of the stylus pen 3 in the touch panel system 1 will be described with reference to FIG. 5. FIG. 5 is a timing diagram showing the basic principle of the synchronization.

The stylus pen 3 detects a dedicated synchronizing signal generated in the timing generator 14 of the touch panel controller 10, in the sense circuit 35 and the synchronizing signal detecting circuit 36. For ease of explanation, the dedicated synchronizing signal has a single pulse.

Assume that a touch panel synchronizing signal S0 which is a dedicated synchronizing signal composed of a single pulse is generated at fixed intervals, as shown in FIG. 5.

In the stylus pen 3, the sense circuit 35 generates a plurality of synchronizing signal candidates S1 to Sp (p is an integer not less than 2). Note that the synchronizing signal candidate Sp shown in FIG. 5 is a signal which is about one cycle behind the synchronizing signal candidate S1. The stylus pen 3 selects a synchronizing signal which has a high degree of coincidence with a dedicated synchronizing signal transmitted from the timing generator 14 of the touch panel controller 10 from among the synchronizing signal candidates S1 to Sp and adopts the synchronizing signal as a synchronizing signal for communication with the touch panel controller 10. In the example shown in FIG. 5, the synchronizing signal candidate S4 or the synchronizing signal candidate S5 that has a high degree of coincidence with the touch panel synchronizing signal S0 is adopted as a pen synchronizing signal of the stylus pen 3.

Until synchronization is achieved, the stylus pen 3 is in detection mode, and driving by the drive circuit 38 is not performed.

The stylus pen 3 can synchronize with a dedicated synchronizing signal in the touch panel controller 10 on the basis of the above-described principle.

### (Synchronization Action of Touch Panel Controller 10 and Stylus Pen 3)

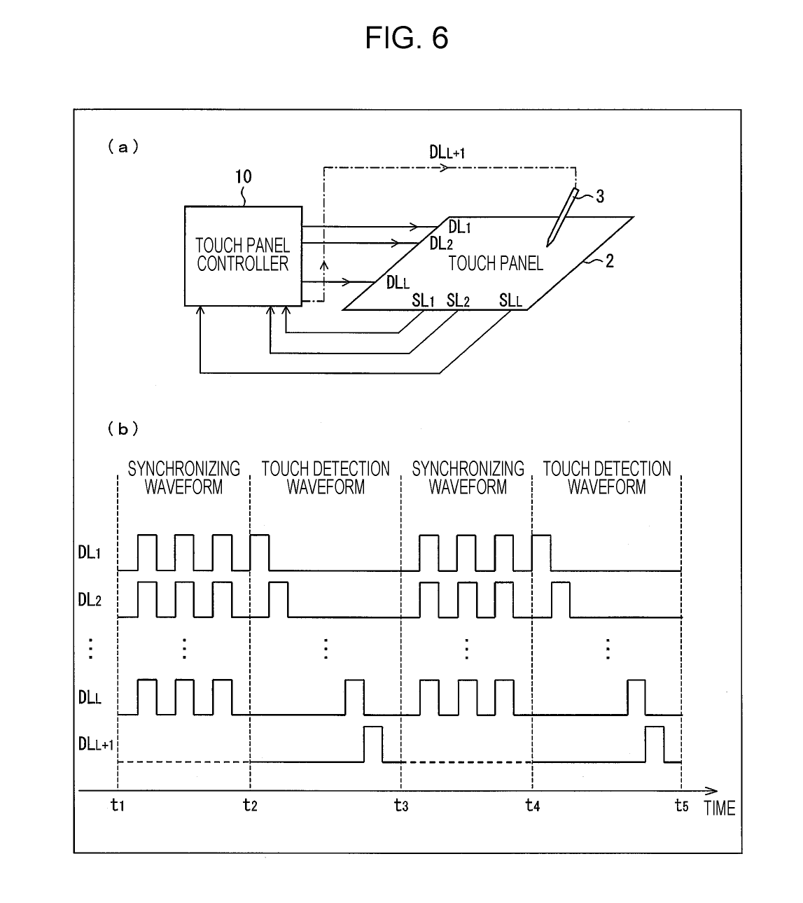

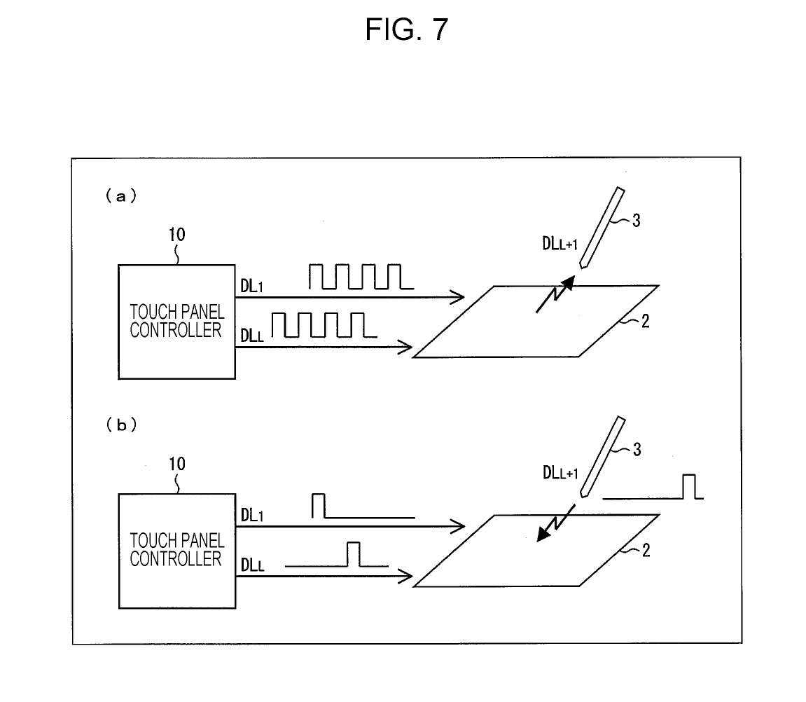

FIG. 6(a) is a diagram showing a relationship of output from the drive lines of the driver 12 and the sense lines of the sense amplifier 13 in the touch panel controller 10 to the touch panel 2 and the stylus pen 3. FIG. 6(b) is a waveform chart showing a synchronizing waveform and a touch detection waveform. FIG. 7(a) is a schematic diagram showing an aspect in which the touch panel controller 10 drives the touch panel 2 by using synchronizing signals, and FIG. 7(b) is a schematic diagram showing an aspect in which the touch panel controller 10 drives the touch panel 2 by using driving signals for detecting a position of the stylus pen 3.

As shown in FIG. 6(a), in the touch panel system 1 according to the present embodiment, a dedicated synchronizing signal of the touch panel controller 10 is created in the timing generator 14 of the touch panel controller 10 and is transmitted by the driver 12 using the drive lines DL₁ to DL_{L}. As a mechanism to notify the stylus pen 3 of a dedicated synchronizing signal that is a driving timing pulse of the touch panel controller 10, the drive lines DL₁ to DL_{L} are driven by using a waveform representing synchronization which is separate from a normal touch detection waveform, as shown in FIG. 6(b). More specifically, in each of the drive lines DL₁ to DL_{L}, a touch detection waveform is generated after a synchronizing waveform is generated.

For example, in a synchronization period from time t1 to time t2, the driver 12 of the touch panel controller 10 drives the drive lines DL₁ to DL_{L} by using a synchronizing waveform with identical rectangular waves (synchronizing signals). The stylus pen 3 receives the synchronizing waveform. In a driving period from time t2 to time t3, the driver 12 drives the drive lines DL₁ to DL_{L} by using touch detection waveforms (driving signals) for detecting a position on the touch panel 2 of the stylus pen 3. The stylus pen 3 outputs a touch detection waveform (a pen driving signal) corresponding to the drive line DL_{L+1} to the touch panel 2. In a synchronization period from time t3 to time t4, the driver 12 then drives the drive lines DL₁ to DL_{L} by using the synchronizing waveform (synchronizing signals). The stylus pen 3 receives the synchronizing waveform. After that, in a driving period from time t4 to time t5, the driver 12 drives the drive lines DL₁ to DL_{L} by using the touch detection waveforms (driving signals). The stylus pen 3 outputs the touch detection waveform (a pen driving signal) corresponding to the drive line DL_{L+1} to the touch panel 2.

Note that touch detection waveforms are generated in sequential driving here for easy understanding of explanation. Generation of a synchronizing waveform is expressed as a plurality of continuous pulses for easy visual distinction from a sequential driving waveform. Actually, for example, a waveform obtained by subjecting M-sequence codes or the like to Manchester coding is easier to detect as a synchronizing waveform. A method for detecting a synchronizing waveform is not limited to the above-described one. For example, a detection method using a correlation output waveform from a matched filter may be used.

### (Reception of Synchronizing Signal by Stylus Pen 3)

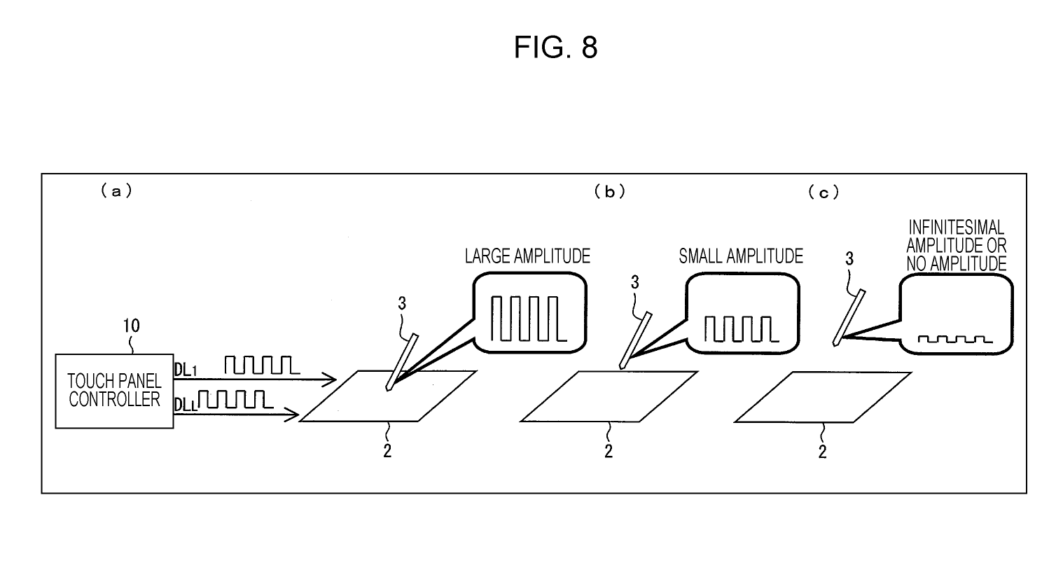

FIG. 8(a) is a schematic diagram showing a position of the stylus pen 3 relative to the touch panel 2 when the touch panel controller 10 is driving the touch panel 2 by using synchronizing signals, FIG. 8(b) is a schematic diagram showing another position of the stylus pen 3 relative to the touch panel 2, and FIG. 8(c) is a schematic diagram showing still another position of the stylus pen 3 relative to the touch panel 2.

The touch panel controller 10 drives the drive lines DL₁ to DL_{L} by using one and the same synchronizing signal (synchronizing waveform). The stylus pen 3 receives the synchronizing signal through the pen tip 31 with the help of the sense circuit 35 and the synchronizing signal detecting circuit 36 (FIG. 4).

Focus on the amplitude of the synchronizing signal received by the stylus pen 3 through the pen tip 31. As shown in FIG. 8(a), the amplitude of the synchronizing signal seems large when the stylus pen 3 is in touch with the touch panel 2. As shown in FIGS. 8(b) and 8(c), the amplitude of the synchronizing signal seems to decrease with distance of the stylus pen 3 from the touch panel 2.

With utilization of the phenomenon, it is possible to determine the presence or absence of a touch of the stylus pen 3 on the touch panel 2 and the distance of the stylus pen 3 from the touch panel 2 by providing a threshold for the amplitude of the synchronizing signal. An actual amplitude of the synchronizing signal depends on the shape of the pen tip 31, and the configurations of the touch panel controller 10 and the touch panel 2. For this reason, the threshold is established in advance through evaluation based on an experiment, a simulation, or the like. A value which allows the stylus pen 3 to be almost certainly determined to be not in touch with the touch panel 2 and is obtained when the stylus pen 3 is as close to the touch panel 2 as possible is determined as the threshold.

(Relationship Between Amplitude of Synchronizing Signal and Distance of Stylus Pen 3 from Touch Panel 2)

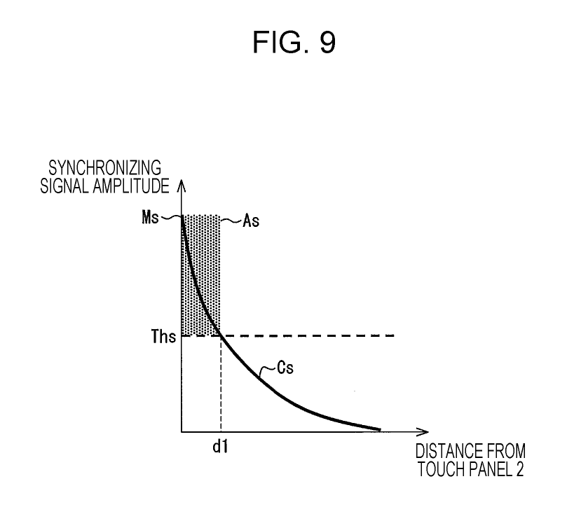

FIG. 9 is a graph showing the relationship between the amplitude of a synchronizing signal detected by the stylus pen 3 and the distance of the stylus pen 3 from the touch panel 2. The abscissa indicates the distance of the stylus pen 3 from the touch panel 2 while the ordinate indicates the amplitude of the synchronizing signal. If the stylus pen 3 is in touch with the touch panel 2, and the distance of the stylus pen 3 from the touch panel 2 is zero, the amplitude of the synchronizing signal is an amplitude Ms. The amplitude of the synchronizing signal decreases with an increase in the distance of the stylus pen 3 from the touch panel 2, as indicated by a curve Cs. Although the amplitude of a signal itself obtained by the pen tip 31 that can be sensed in the sense circuit 35 is treated as the amplitude of the synchronizing signal here, a peak level of the correlation between an expected synchronizing waveform and an actually received waveform which can be sensed in the synchronizing signal detecting circuit 36 may be treated as the amplitude of the synchronizing signal.

A threshold Ths corresponding to a distance d1, at which the stylus pen 3 can be almost certainly determined to be not in touch with the touch panel 2 and at which the stylus pen 3 is as close to the touch panel 2 as possible, is determined as the threshold for determining the presence or absence of a touch. If the amplitude of the synchronizing signal is not more than the threshold Ths, the absence of a touch can be certainly determined. If the amplitude of the synchronizing signal exceeds the threshold Ths, the presence of a touch is determined. Although the actual presence or absence of a touch can be more precisely determined when the threshold Ths is as large as possible, the threshold Ths is determined with the emphasis on the certainty of determination of the absence of a touch. A range expressed as a region As is a range within which determination of the absence of a touch based on the amplitude of the synchronizing signal is less reliable.

### (Updating of Threshold of Writing Pressure Sensor 31d Based on Amplitude of Synchronizing Signal)

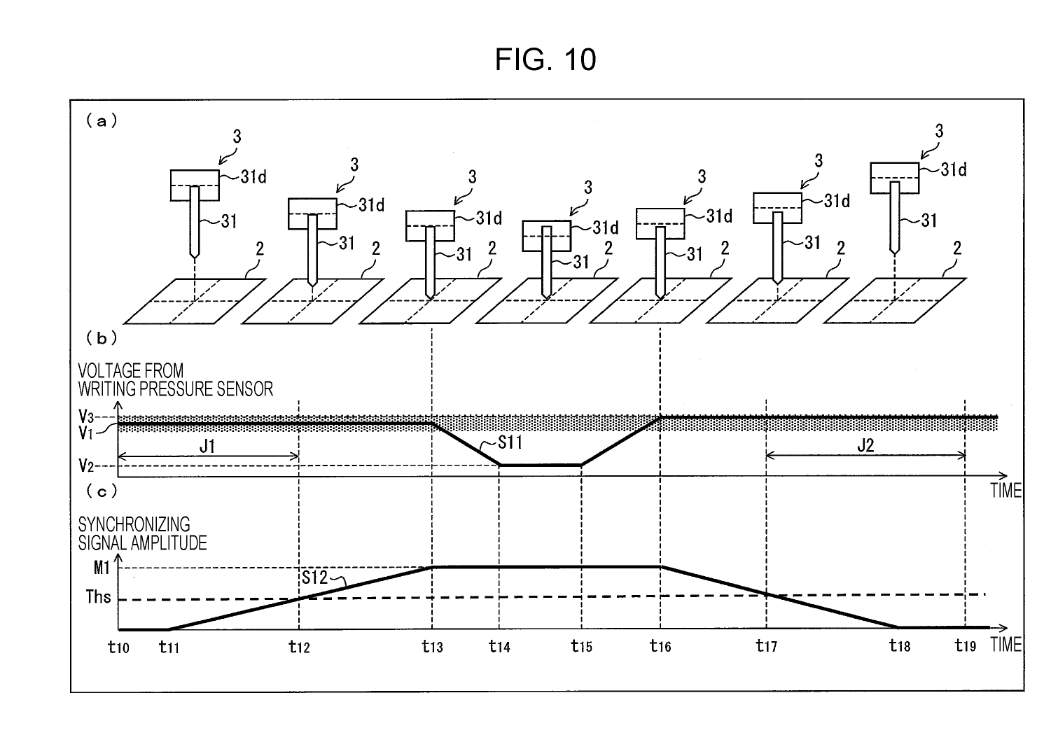

FIG. 10(a) is a schematic diagram for explaining transition of the positional relationship of the stylus pen 3 with the touch panel 2, FIG. 10(b) is a graph showing transition of a voltage from the writing pressure sensor 31d provided in the stylus pen 3, and FIG. 10(c) is a graph showing transition of the amplitude of a synchronizing signal detected by the stylus pen 3.

A voltage corresponding to a writing pressure detected by the writing pressure sensor 31d and the amplitude of the synchronizing signal corresponding to the distance of the stylus pen 3 from the touch panel 2 change in the manners below in response to an operation of the stylus pen 3 by a user.

A voltage S11 with a voltage value V1 is output from the writing pressure sensor 31d of the stylus pen 3 that is away from the touch panel 2. As the stylus pen 3 approaches the touch panel 2, the synchronizing signal is sensed by the stylus pen 3 at time t11, and an amplitude S12 of the synchronizing signal increases at and after time t11. At time t12, the amplitude S12 of the synchronizing signal exceeds the threshold Ths, and the stylus pen 3 is determined to have come into touch with the touch panel 2. After that, at time t13, the stylus pen 3 actually comes into touch with the touch panel 2, and the amplitude S2 of the synchronizing signal arrives at an amplitude value M1.

If the writing pressure of the stylus pen 3 is increased from time t13 to time t14, the pen tip 31 moves in the axial direction toward the writing pressure sensor 31d. The voltage S11 output from the writing pressure sensor 31d decreases from the voltage value V1 to a voltage value V2. The amplitude S2 of the synchronizing signal maintains the amplitude value M1.

If the writing pressure of the stylus pen 3 is maintained from time t14 to time t15, the pen tip 31 remains at a position in the axial direction, and the voltage S11 from the sensor 31d remains at the voltage V2. The amplitude S2 of the synchronizing signal maintains the amplitude value M1.

After that, if the writing pressure of the stylus pen 3 is decreased to zero from time t15 to time t16, the pen tip 31 moves in the axial direction in a direction away from the writing pressure sensor 31d and returns to beyond an original position before time t13. The voltage S11 from the writing pressure sensor 31d increases to a voltage V3 higher than the original voltage V1 before time t13. The amplitude S12 of the synchronizing signal maintains the amplitude value M1.

If the stylus pen 3 is moved away from the touch panel 2 from time t16 to time t17, and a zero-writing-pressure state is maintained, the pen tip 31 remains at a return position beyond the original position, and the voltage S11 from the writing pressure sensor 31d remains at the voltage value V3. The amplitude S12 of the synchronizing signal starts decreasing from the amplitude value M1 and arrives at the threshold Ths, and the stylus pen 3 is determined to have come out of touch with the touch panel 2.

If the stylus pen 3 is moved further away from the touch panel 2, the amplitude S12 of the synchronizing signal decreases further from the threshold Ths and arrives at an amplitude value of zero at time t18.

With utilization of the relationship between the change in the voltage S11 from the writing pressure sensor 31d and the change in the amplitude S12 of the synchronizing signal, only voltage values from the writing pressure sensor 31d when the stylus pen 3 is actually not in touch with the touch panel 2 in a period J1 and a period J2 when the stylus pen 3 is determined, from the synchronizing signal amplitude, to be not in touch with the touch panel 2 can be used. For this reason, a threshold for determining the presence or absence of a touch which is used for a voltage output from the writing pressure sensor 31d can be more accurately established. The threshold may be established on the basis of a value, which is obtained by acquiring the voltage from the writing pressure sensor 31d a plurality of number of times in the periods J1 and J2 when the absence of a touch is determined and averaging acquired values, in view of noise or may be established on the basis of a value obtained through filtering, such as taking a minimum value of the voltage acquired a plurality of times. A threshold slightly lower than the above-described threshold may be set as an actual threshold to leave a sufficient margin.

### Second Embodiment

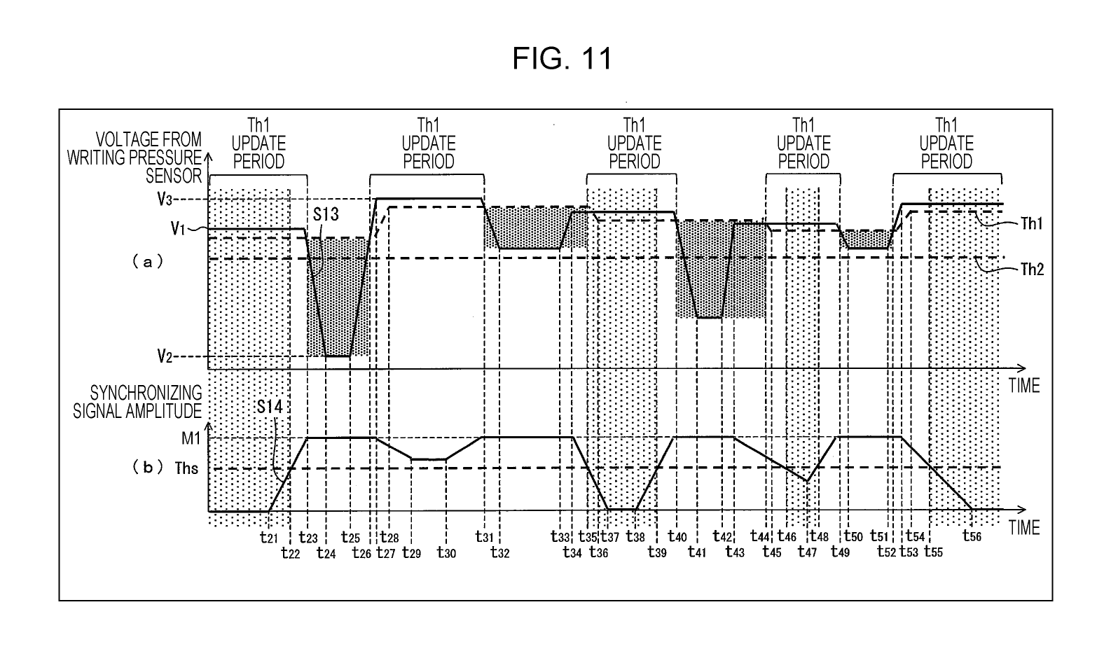

A second embodiment of the present invention will be described with reference to FIG. 11 as follows. Note that, for convenience of explanation, members having the same functions as those of the members described in the above-described embodiment are denoted by the same reference characters and that a description of the members will be omitted.

In addition to the threshold setting method described with reference to FIG. 10 in the first embodiment, the threshold setting method to be described below may be introduced.

FIG. 11(a) is a graph showing transition of a voltage S13 from a writing pressure sensor 31d provided in a stylus pen 3 according to the second embodiment and thresholds for determining the presence or absence of a writing pressure by the writing pressure sensor 31d, and FIG. 11(b) is a graph showing transition of an amplitude S14 of a synchronizing signal detected by a stylus pen 3.

In the threshold setting method according to the second embodiment, the following thresholds are prepared:

Threshold Th1: A threshold for determining whether the stylus pen 3 has come into touch with the touch panel 2. The threshold Th1 is established on the basis of a voltage value from the writing pressure sensor 31d in a period when the absence of a touch is determined from the amplitude of a synchronizing signal from a touch panel controller 10 and a voltage value from the writing pressure sensor 31d in a period when the absence of a touch is determined by the writing pressure sensor 31d.
Threshold Th2: A threshold for determining whether a certain level of writing pressure is applied. The threshold Th2 is established on the basis of a lower limit for variations in the voltage value from the writing pressure sensor 31d which are obtained when the stylus pen 3 is not in touch with the touch panel 2.
Threshold Th3: A threshold for determining whether the voltage value from the writing pressure sensor 31d has not changed between the threshold Th1 and the threshold Th2 for a fixed time.

The voltage S13 with a voltage value V1 is output from the writing pressure sensor 31d of the stylus pen 3 that is away from the touch panel 2. As the stylus pen 3 approaches the touch panel 2, the synchronizing signal is sensed by the stylus pen 3 at time t21, and the amplitude S14 of the synchronizing signal increases at and after time t21. At time t22, the amplitude S14 of the synchronizing signal exceeds a threshold Ths, and the stylus pen 3 is determined to have come into touch with the touch panel 2. After that, at time t23, the stylus pen 3 actually comes into touch with the touch panel 2, and the amplitude S14 of the synchronizing signal arrives at an amplitude value M1.

If the writing pressure of the stylus pen 3 is increased from time t23 to time t24, a pen tip 31 moves in an axial direction toward the writing pressure sensor 31d. The voltage S13 output from the writing pressure sensor 31d decreases from the voltage value V1 to below the threshold Th1. With this decrease, the stylus pen 3 is determined to have come into touch with the touch panel 2.

The voltage S13 from the writing pressure sensor 31d falls below the threshold Th2 and decreases to a voltage value V2 at time t24. The amplitude S14 of the synchronizing signal maintains the amplitude value M1.

If the writing pressure of the stylus pen 3 is maintained from time t24 to time t25, the pen tip 31 remains at a position in the axial direction, and the voltage S13 from the sensor 31d remains at the voltage value V2. The amplitude S14 of the synchronizing signal maintains the amplitude value M1.

After that, if the writing pressure of the stylus pen 3 is decreased to zero from time t25 to time t27, the pen tip 31 moves in the axial direction in a direction away from the writing pressure sensor 31d and returns to beyond an original position before time t23. The voltage S13 from the writing pressure sensor 31d exceeds the threshold Th1 at time t26, and the stylus pen 3 is determined, from the threshold Th1, to have come out of touch with the touch panel 2. After that, the voltage S13 from the writing pressure sensor 31d continues increasing to time t27 and arrives at a voltage value V3 higher than the original voltage V1 before time t23. The stylus pen 3 starts moving away from the touch panel 2 at time t27, and the amplitude S14 of the synchronizing signal starts decreasing at time t27.

The threshold Th1 is updated on the basis of the voltage value V3 of the voltage S13 from the writing pressure sensor 31d at time t28. The amplitude S14 of the synchronizing signal continues decreasing. The amplitude S14 of the synchronizing signal further continues decreasing to time t29. After that, the stylus pen 3 maintains a distance from the touch panel 2 from time t29 to time t30, and the amplitude S14 of the synchronizing signal maintains an amplitude value higher than the threshold Ths from time t29 to time t30.

At time t30, the stylus pen 3 starts approaching the touch panel 2 again, and the amplitude S14 of the synchronizing signal arrives at the amplitude value M1. The voltage S13 from the writing pressure sensor 31d starts decreasing from the voltage value V3. At time t31, the voltage S13 from the writing pressure sensor 31d falls below the updated threshold Th1. With this fall, the stylus pen 3 is determined to have come into touch with the touch panel 2 again. The amplitude S14 of the synchronizing signal maintains the amplitude value M1.

The voltage S13 from the writing pressure sensor 31d decreases to a voltage value higher than the threshold Th2 at time t32. The amplitude S14 of the synchronizing signal maintains the amplitude value M1. If the writing pressure of the stylus pen 3 is maintained from time t32 to time t33, the pen tip 31 remains at a position in the axial direction, and the voltage S13 from the sensor 31d remains at the voltage value higher than the threshold Th2. The amplitude S14 of the synchronizing signal maintains the amplitude value M1.

After that, if the writing pressure of the stylus pen 3 is decreased to zero from time t33 to time t34, the pen tip 31 moves in the axial direction in a direction away from the writing pressure sensor 31d and returns to a position on this side of a position before the touch from time t27. The voltage S13 from the sensor 31d increases to a voltage value lower than the threshold Th1 from time t33 to time t34. The amplitude S14 of the synchronizing signal maintains the amplitude value M1 to time t34. At and after time t34, the stylus pen 3 starts moving away from the touch panel 2. The voltage S13 from the sensor 31d maintains the voltage value lower than the threshold Th1. The amplitude S14 of the synchronizing signal starts decreasing from the amplitude value M1 and arrives at the threshold Ths at time t35. With this arrival, the stylus pen 3 is determined to have come out of touch with the touch panel 2.

At time t36, the threshold Th1 is updated to be a voltage value slightly lower than that of the voltage S13 from the sensor 31d. At time t37, the stylus pen 3 is enough away from the touch panel 2, and the amplitude S14 of the synchronizing signal arrives at an amplitude value of zero. After that, the stylus pen 3 starts approaching the touch panel 2 again. The amplitude S14 of the synchronizing signal starts increasing at time t38 and exceeds the threshold Ths at time t39. The amplitude S14 of the synchronizing signal arrives at the amplitude value M1. The stylus pen 3 is pushed into the touch panel 2, and the voltage S13 from the sensor 31d starts decreasing. The voltage S13 from the sensor 31d falls below the threshold Th1 at time t40. With this fall, the stylus pen 3 is determined to have come into touch with the touch panel 2 for a third time.

The voltage S13 from the writing pressure sensor 31d falls below the threshold Th2, and decreases to a voltage value higher than the voltage value V2 at time t41. The amplitude S14 of the synchronizing signal maintains the amplitude value M1. The voltage S13 from the writing pressure sensor 31d maintains the voltage value higher than the voltage value V2 to time t42. After that, the writing pressure of the stylus pen 3 on the touch panel 2 decreases to zero from time t42 to time t43, and the voltage S13 from the writing pressure sensor 31d increases to a voltage value lower than the threshold Th1.

The stylus pen 3 starts moving away from the touch panel 2, and the amplitude S14 of the synchronizing signal starts decreasing from the amplitude value M1. At time t44, the stylus pen 3 is determined, from the threshold Th3, to have come out of touch with the touch panel 2. After that, the threshold Th1 is updated on the basis of the voltage S13 from the sensor 31d at time t45. The amplitude S14 of the synchronizing signal arrives at the threshold Ths at time t46 and decreases to an amplitude value lower than the threshold Ths at time t47. The amplitude S14 of the synchronizing signal recovers to the threshold Ths at time t48. The stylus pen 3 comes into touch with the touch panel, and the amplitude S14 of the synchronizing signal arrives at the amplitude value M1. After that, if the stylus pen 3 is pushed into the touch panel, the voltage S13 from the sensor 31d starts decreasing. The voltage S13 from the sensor 31d arrives at the threshold Th1 at time t49. With this arrival, the stylus pen 3 is determined to have come into touch with the touch panel 2 for a fourth time.

The writing pressure increases further, and the voltage S13 from the sensor 31d decreases to a voltage value higher than the threshold Th2 at time t50. After that, the writing pressure is maintained from time t50 to time t51, and the voltage S13 from the sensor 31d remains at the voltage value higher than the threshold Th2. At time t51, the writing pressure of the stylus pen 3 starts decreasing, and the voltage S13 from the sensor 31d starts increasing.

The voltage S13 from the sensor 31d exceeds the threshold Th1 at time t52. The stylus pen 3 is determined, from the threshold Th1, to have come out of touch with the touch panel 2. After that, at time t53, the voltage S3 from the sensor 31d arrives at a voltage value higher than the voltage value from time t43. The stylus pen 3 starts moving away from the touch panel 2, and the amplitude S14 of the synchronizing signal starts decreasing from the amplitude value M1.

At time t54, the threshold Th1 is updated on the basis of the voltage value of the voltage S13 higher than the voltage value from time t43. The amplitude S14 of the synchronizing signal decreases to arrive at the threshold Ths at time t55. After that, the stylus pen 3 moves further away from the touch panel 2, and the amplitude S14 of the synchronizing signal arrives at an amplitude value of zero at time t56.

When the third touch ends at time t43, the voltage S13 from the sensor 31d is a little short of the voltage value before the third touch. Immediately after the second touch at time t34, the voltage S13 from the sensor 31d is a little short of the voltage value before the second touch. Since the stylus pen 3 moves away from the touch panel 2 right away, and the threshold Th1 is updated, the absence of a touch is determined. In contrast, at the end of the third touch at time t43, the threshold Th1 is not updated, and there is a problem in that determination of the presence of a touch persists.

For this reason, the threshold Th3 is prepared. When the voltage S13 from the sensor 31d is below the threshold Th1, the stylus pen 3 is in a state where the presence of a touch is determined. Note that if the voltage S13 from the sensor 31d is above the threshold Th2, the above-described problem may be occurring.

For this reason, a threshold (1) for detecting that there is no voltage change and a threshold (2) for detecting that a fixed period of time has elapsed in a state where the voltage S13 from the sensor 31d remains between the threshold Th1 and the threshold Th2 are provided. The threshold Th1 is updated if there is no voltage change, and the fixed period of time has elapsed. The threshold (1) for detecting that there is no voltage change and the threshold (2) for detecting that the fixed period of time has elapsed are collectively expressed as the threshold Th3.

### Third Embodiment

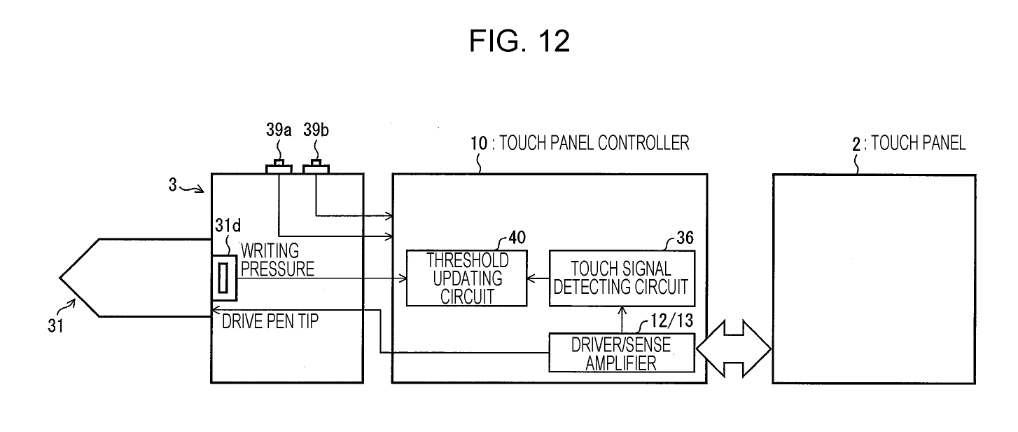

FIG. 12 is a schematic diagram showing the configuration of a touch panel system according to a third embodiment. The same components as those described in the above embodiments are denoted by the same reference characters. A detailed description of the components will be omitted.

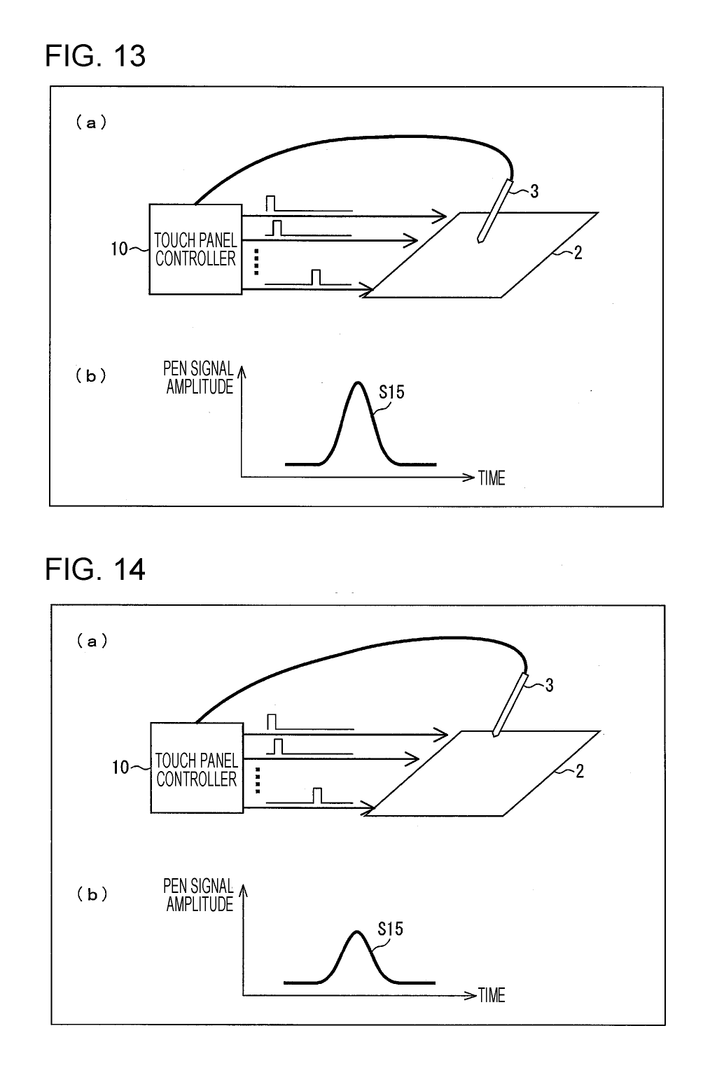

In the first embodiment, the threshold updating circuit 40 that updates a threshold of the writing pressure sensor 31d in accordance with a synchronizing signal supplied from the touch panel controller 10 is provided inside the stylus pen 3. The present invention, however, is not limited to this. If a stylus pen 3 is wire-connected to a touch panel controller 10 by a signal line, a synchronizing signal is unnecessary. In this case, the amplitude of a synchronizing signal cannot be used. As shown in FIG. 12, threshold updating processing by a threshold updating circuit 40 is carried out on the touch panel controller 10 side on the basis of the magnitude of a signal of touch (a pen signal waveform S15 (FIGS. 13 to 15)). The threshold updating processing is preferably carried out on the touch panel controller 10 side because the configuration of the stylus pen 3 is simpler. Of course, even if the threshold updating processing is carried out inside the stylus pen 3, the processing itself has no problem.

Although an example is illustrated in which two switches, a first operation switch 39a and a second operation switch 39b, are provided, the present invention is not limited to this. Three or more operation switches may be provided at the stylus pen 3. The number of signal lines which connect the stylus pen 3 and the touch panel controller 10 can be reduced by integrating the statuses of the operation switches and a voltage representing a writing pressure into one and expressing the one as a potential.

The present embodiment illustrates an example in which an output from a touch detecting circuit 36 is handled by the threshold updating circuit 40 instead of a synchronizing signal amplitude used in the first and second embodiments.

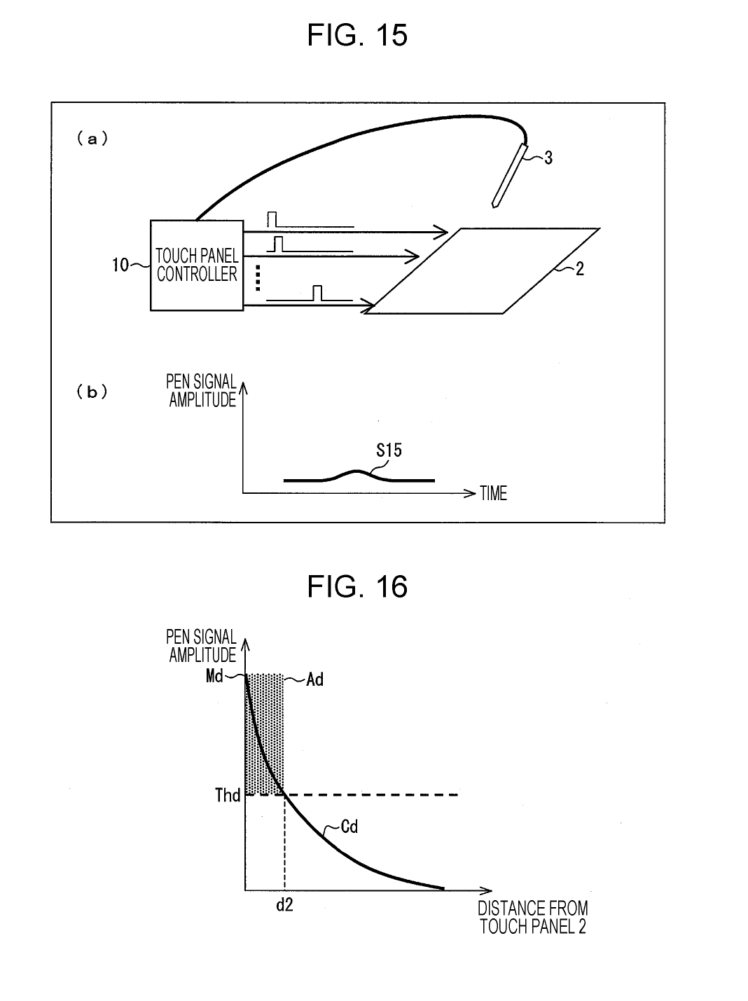

FIG. 13(a) is a schematic diagram for explaining a positional relationship between a touch panel 2 and the stylus pen 3 in the touch panel system according to the third embodiment, and FIG. 13(b) is a waveform chart showing the pen signal waveform S15 that is obtained by the touch panel controller 10 in response to a pen driving signal output by the stylus pen 3 of the touch panel system. FIG. 14(a) is a schematic diagram for explaining another positional relationship between the touch panel 2 and the stylus pen 3 in the touch panel system, and FIG. 14(b) is a waveform chart showing the pen signal waveform S15 that is obtained by the touch panel controller 10 in response to a pen driving signal associated with the positional relationship. FIG. 15(a) is a schematic diagram for explaining still another positional relationship between the touch panel 2 and the stylus pen 3 in the touch panel system, and FIG. 15(b) is a waveform chart showing the pen signal waveform S15 that is obtained by the touch panel controller 10 in response to a pen driving signal associated with the positional relationship.

In the touch panel system according to the third embodiment, the stylus pen 3 is wire-connected to the touch panel controller 10 by a signal line. The stylus pen 3 drives a pen tip 31 in accordance with a signal from the touch panel controller 10, and the touch panel controller 10 obtains the pen signal waveform S15 through the touch panel 2. Focus on the amplitude of the pen signal waveform S15 that the touch panel controller 10 obtains through the touch panel 2, in the touch panel system.

When the stylus pen 3 is in touch with the touch panel 2, the amplitude of the pen signal waveform S15 that the touch panel controller 10 obtains through the touch panel 2 seems large. The amplitude of the pen signal waveform S15 seems to decrease with distance of the stylus pen 3 from the touch panel 2.

With utilization of the phenomenon, it is possible to determine the presence or absence of a touch of the stylus pen 3 on the touch panel 2 by providing a threshold for the amplitude of the pen signal waveform S15 to be sensed by the touch panel controller 10. An actual amplitude of the pen signal waveform S15 depends on the shape of the pen tip 31, and the configurations of the touch panel controller 10 and the touch panel 2. For this reason, the threshold for the pen signal waveform S15 is established in advance through evaluation based on an experiment, a simulation, or the like. A value which allows the stylus pen 3 to be almost certainly determined to be not in touch with the touch panel 2 and is obtained when the stylus pen 3 is as close to the touch panel 2 as possible is determined as the threshold for the pen signal waveform S15.

FIG. 16 is a graph showing the relationship between the amplitude of the pen signal waveform S15 that the touch panel controller 10 obtains through the touch panel 2 in response to a pen driving signal output by the stylus pen 3 and the distance of the stylus pen 3 from the touch panel 2. The abscissa indicates the distance of the stylus pen 3 from the touch panel 2 while the ordinate indicates the amplitude of the pen signal waveform S15. If the stylus pen 3 is in touch with the touch panel 2, and the distance of the stylus pen 3 from the touch panel 2 is zero, the amplitude of the pen signal waveform S15 is an amplitude Md. The amplitude of the pen signal waveform S15 decreases exponentially with an increase in the distance of the stylus pen 3 from the touch panel 2, as indicated by a curve Cd.

A threshold Thd corresponding to a distance d2, at which the stylus pen 3 can be almost certainly determined to be not in touch with the touch panel 2 and at which the stylus pen 3 is as close to the touch panel 2 as possible, is determined as a threshold for determining the presence or absence of a touch. If the amplitude of the pen signal waveform S15 is not more than the threshold Thd, the absence of a touch can be certainly determined. If the amplitude of the pen signal waveform S15 exceeds the threshold Thd, the presence of a touch is determined. Although the presence or absence of a touch can be more precisely determined when the threshold Thd is as large as possible, the threshold Thd is determined with the emphasis on the certainty of determination of the presence or absence of a touch. A range expressed as a region Ad is a range within which determination of the presence or absence of a touch based on the amplitude of the pen signal waveform S15 is less reliable.

### Fourth Embodiment

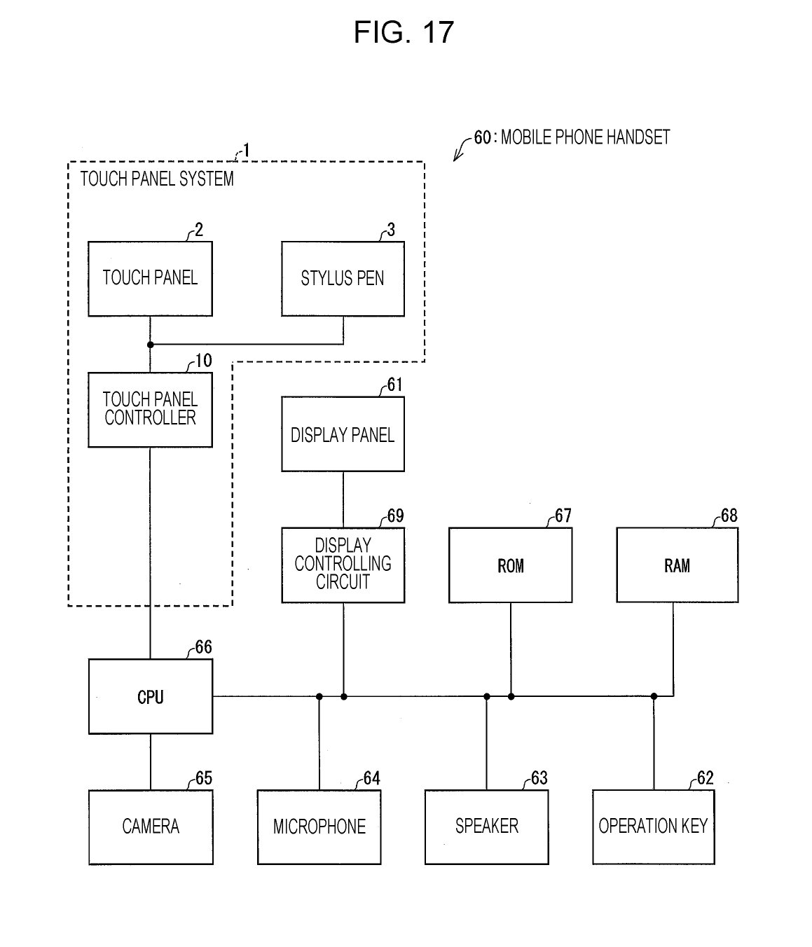

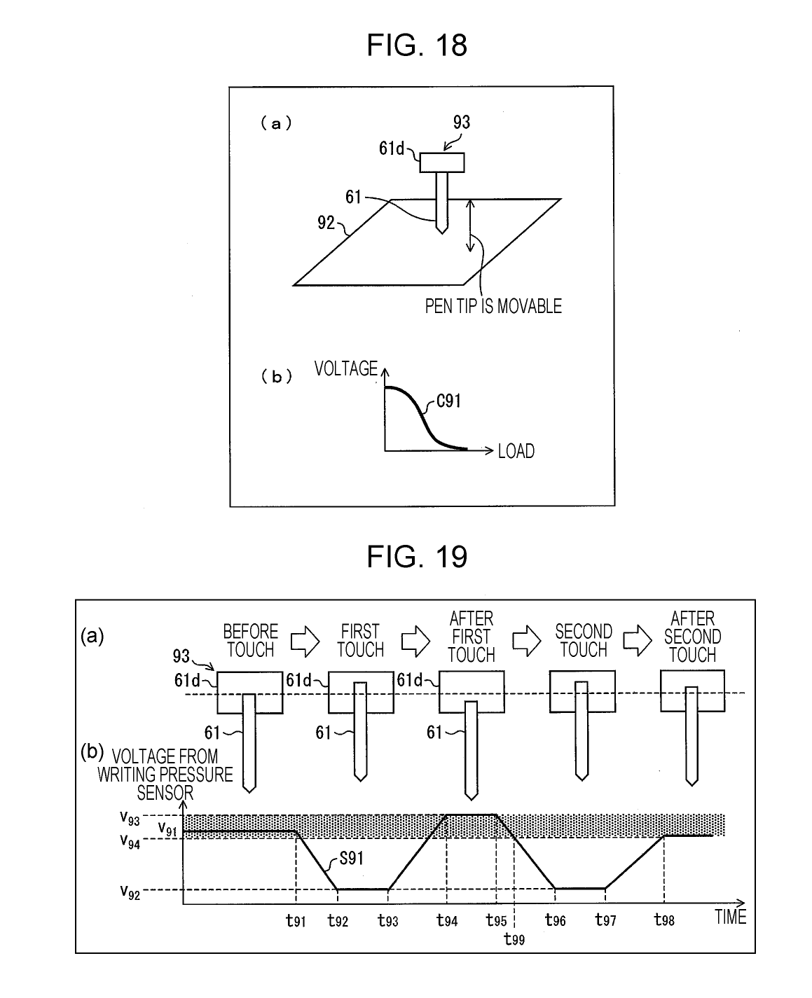

Still another embodiment of the present invention will be described with reference to FIG. 17 as follows. Note that elements other than elements to be described in the present embodiment are the same as those in the first to third embodiments. For convenience of explanation, members having the same functions as those of the members illustrated in the drawings associated with the first to third embodiments are denoted by the same reference characters, and a description of the members will be omitted.

In the present embodiment, a case where a touch panel system 1 is installed in a mobile phone handset 60 as an electronic device will be described with reference to FIG. 17. FIG. 17 is a block diagram showing the configuration of the mobile phone handset 60 according to the fourth embodiment.

As shown in FIG. 17, the mobile phone handset 60 according to the present embodiment includes the touch panel system 1, a display panel 61, operation keys 62, a speaker 63, a microphone 64, a camera 65, a CPU 66, a ROM 67, a RAM 68, and a display controlling circuit 69. The components are connected to one another by a data bus.

As described earlier, the touch panel system 1 has a touch panel 2, a touch panel controller 10 which detects an electrostatic capacity or an electrostatic capacity difference, and a stylus pen 3.

The display panel 61 displays an image stored in the ROM 67 or the RAM 68 with the help of the display controlling circuit 69. The display panel 61 is laid over the touch panel 2 or incorporates the touch panel 2. Note that it is also possible to give a touch recognition signal generated by a touch recognition unit 17 and indicating a touch position on the touch panel 2 the same role as that of a signal indicating that the operation key 62 is operated.

The operation keys 62 receive input of an instruction from a user of the mobile phone handset 60.

The speaker 63 outputs, for example, sound based on music data or the like stored in the RAM 68.

The microphone 64 receives input of voice of the user. The mobile phone handset 60 digitizes the input voice (analog data). The mobile phone handset 60 sends the digitized voice to a communication partner (for example, another mobile phone handset).

The camera 65 captures an object in accordance with an operation of the operation key 62 by the user. Note that image data of the captured object is stored in the RAM 68 or an external memory (for example, a memory card).

The CPU 66 controls the action of the touch panel system 1 and the mobile phone handset 60. The CPU 66 executes, for example, a program stored in the ROM 67.

The ROM 67 stores data in a nonvolatile manner. The ROM 67 is a writable and erasable ROM, such as an erasable programmable read-only memory (EPROM) or a flash memory. Note that although not shown in FIG. 17, the mobile phone handset 60 may include an interface (IF) for the mobile phone handset 60 to wire-connect to another electronic device.

The RAM 68 stores, in a volatile manner, data generated through execution of a program by the CPU 66 or data input via the operation key 62.

As described above, the mobile phone handset 60 as an electronic device according to the present embodiment includes the touch panel system 1. It is thus possible to provide the mobile phone handset 60 as an electrode device including the touch panel system 1 with the stable sensitivity of the stylus pen 3 to the touch panel 2.

### [Software-Based Implementation Example]

Each of control blocks (a threshold updating circuit 40 and a control circuit 33 in particular) of the stylus pen 3 and the threshold updating circuit 40 of the touch panel controller 10 may be implemented by a logic circuit (hardware) formed in an integrated circuit (IC chip) or the like or may be implemented by software using a central processing unit (CPU).

In the latter case, the threshold updating circuit 40 or the like includes a CPU which executes instructions of a program as a piece of software implementing functions, a read only memory (ROM) or a storage device (referred to as a “recording medium”) on or in which the program and various data are recorded in a manner readable by a computer (or a CPU), a random access memory (RAM) onto which the program is loaded, and the like. The object of the present invention is attained when a computer (or a CPU) reads out the program from the recording medium and executes the program. A “non-transitory tangible medium”, such as a tape, a disc, a card, a semiconductor memory, or a programmable logic circuit, can be used as the recording medium. The program may be supplied to the computer via an arbitrary transmission medium (for example, a communication network or broadcast waves) that is capable of transmitting the program. Note that the present invention can be implemented in the form of a data signal embedded in a carrier wave in which the program is embodied through electronic transmission.

### CONCLUSION

The touch panel system 1 according to a first aspect of the present invention is the touch panel system 1 for detecting a position on the touch panel 2 of a touch pen (the stylus pen 3) in touch with the touch panel 2. The touch pen (the stylus pen 3) includes the pen tip 31 that is provided to be movable in an axial direction in accordance with a writing pressure and the writing pressure sensor 31d that generates a signal corresponding to the amount of movement of the pen tip 31. The threshold updating circuit 40 is provided to update a threshold for determining, by the writing pressure sensor 31d, the presence or absence of the writing pressure on the basis of the distance between the touch pen (the stylus pen 3) and the touch panel 2.

According to the above-described configuration, the threshold for determining, by the writing pressure sensor 31d, the presence or absence of the writing pressure is updated on the basis of the distance between the stylus pen 3 and the touch panel 2. For this reason, each time the stylus pen 3 is pushed into and moved away from the touch panel 2, the threshold of the writing pressure sensor 31d can be updated. Even in a case where each time the stylus pen 3 is pushed into and moved away from the touch panel 2, a return position of the pen tip 31 varies, the threshold can be updated with each variation in the return position of the pen tip 31. As a result, even if each time the stylus pen 3 is pushed into and moved away from the touch panel 2, the return position of the pen tip 31 varies, the sensitivity of the stylus pen 3 to the touch panel 2 can be stabilized.

In a touch panel system according to a second aspect of the present invention in the first aspect, the touch panel 2 may have respective capacitors formed at intersections of a plurality of first signal lines (the horizontal signal lines HL₁ to HL_{K}) and a plurality of second signal lines (the vertical signal lines VL₁ to VL_{L}). The touch panel system may further include a control unit (the touch panel controller 10) which controls the touch panel 2. The control unit (the touch panel controller 10) may drive the first signal lines by using a synchronizing signal for synchronizing the action of the touch pen (the stylus pen 3) and the action of the control unit (the touch panel controller 10) in a synchronization period. The touch pen (the stylus pen 3) may further include a synchronizing circuit (the sense circuit 35 and the synchronizing signal detecting circuit 36) which detects the synchronizing signal. The threshold updating circuit 40 may update the threshold of the writing pressure sensor 31d on the basis of an amplitude of the synchronizing signal.

According to the above-described configuration, the threshold of the writing pressure sensor 31d can be updated with the use of the synchronizing signal for synchronizing the action of the stylus pen 3 and the action of the touch panel controller 10.

In a touch panel system according to a third aspect of the present invention in the first aspect, the touch panel 2 may have respective capacitors formed at intersections of a plurality of first signal lines (the horizontal signal lines HL₁ to HL_{K}) and a plurality of second signal lines (the vertical signal lines VL₁ to VL_{L}). The touch panel system may further include a control unit (the touch panel controller 10) which controls the touch panel 2. The control unit (the touch panel controller 10) may drive the first signal lines by using a driving signal for detecting a position on the touch panel 2 of the touch pen (the stylus pen 3) in a driving period. The touch pen (the stylus pen 3) may further include a pen driving circuit (the drive circuit 38) which drives the first signal lines by using a pen driving signal in the driving period. The threshold updating circuit 40 may update the threshold of the writing pressure sensor 31d on the basis of an amplitude of a pen signal waveform which is obtained through the touch panel 2 in response to the pen driving signal.

According to the above-described configuration, the threshold of the writing pressure sensor 31d can be updated with the use of the pen driving signal for driving drive lines in the driving period.

In a touch panel system according to a fourth aspect of the present invention in the first aspect, the threshold updating circuit 40 may be provided in the touch pen (the stylus pen 3).

According to the above-described configuration, the touch panel controller 10 has a simpler configuration.

A touch panel system according to a fifth aspect of the present invention in the first aspect may further include a control unit (the touch panel controller 10) which controls the touch panel 2. The threshold updating circuit 40 may be provided in the control unit (the touch panel controller 10).

According to the above-described configuration, the stylus pen 3 has a simpler configuration.

The present invention is not limited to the above-described embodiments, and various changes can be made within the scope of the claims. An embodiment obtained by appropriately combining technical means disclosed in different embodiments is also included in the technical scope of the present invention. Additionally, a new technical feature can be formed by combining technical means disclosed in the embodiments.

### INDUSTRIAL APPLICABILITY

The present invention can be applied to a touch panel system for detecting a position on a touch panel of a touch pen in touch with the touch panel and an electronic device including the touch panel system.

### REFERENCE SIGNS LIST

1 touch panel system
2 touch panel
3 stylus pen (touch pen)
10 touch panel controller (control unit)
11 multiplexer
12 driver
13 sense amplifier
14 timing generator
15 AD converter
16 capacity distribution calculation unit
17 touch recognition unit
18 pen position detection unit
30 pen main body
30a grasp unit
31 pen tip
31a pen tip cover
31b pen tip shaft
31c insulator
31d writing pressure sensor
32 connection switch
3 control circuit
34a, 34b action selector switch
35 sense circuit (synchronizing circuit)
36 synchronizing signal detecting circuit (synchronizing circuit)
37 timing adjusting circuit
38 drive circuit (pen driving circuit)
39a first operation switch
39b second operation switch
60 mobile phone handset (electronic device)
61 display panel
61 operation key
63 speaker
64 microphone
65 camera
66 CPU
67 ROM
68 RAM
69 display controlling circuit
C11 to CKL capacitor
DL₁ to DL_{K} to DL_{L} drive line
HL₁ to HL_{K} horizontal signal line (first signal line or second signal line)
SL₁ to SL_{K} to SL_{L} sense line
VL₁ to VL_{K} to VL_{L} vertical signal line (first signal line or second signal line)

1. A touch panel system for detecting a position on a touch panel of a touch pen in touch with the touch panel, wherein
the touch pen includes a pen tip which is provided to be movable in an axial direction in accordance with a writing pressure and a writing pressure sensor which generates a signal corresponding to the amount of movement of the pen tip, and
a threshold updating circuit is provided to update a threshold for determining, by the writing pressure sensor, presence or absence of the writing pressure on the basis of a distance between the touch pen and the touch panel.

2. The touch panel system according to claim 1, wherein
the touch panel has respective capacitors formed at intersections of a plurality of first signal lines and a plurality of second signal lines,
the touch panel system further includes a control unit which controls the touch panel,
the control unit drives the first signal lines by using a synchronizing signal for synchronizing action of the touch pen and action of the control unit in a synchronization period,
the touch pen further includes a synchronizing circuit which detects the synchronizing signal, and
the threshold updating circuit updates the threshold of the writing pressure sensor on the basis of an amplitude of the synchronizing signal.

3. The touch panel system according to claim 1, wherein
the touch panel has respective capacitors formed at intersections of a plurality of first signal lines and a plurality of second signal lines,
the touch panel system further includes a control unit which controls the touch panel,
the control unit drives the first signal lines by using a driving signal for detecting the position on the touch panel of the touch pen in a driving period,
the touch pen further includes a pen driving circuit which drives the first signal lines by using a pen driving signal in the driving period, and
the threshold updating circuit updates the threshold of the writing pressure sensor on the basis of an amplitude of a pen signal waveform which is obtained through the touch panel in response to the pen driving signal.

4. The touch panel system according to claim 1, wherein
the threshold updating circuit is provided in the touch pen.

5. An electronic device comprising a touch panel system according to claim 1.
